(19) United States
(12) Patent Application Publication
(10) Pub. No.: US 2026/0121756 A1
(43) Pub. Date: Apr. 30, 2026

(54) DIRECTLY MODULATED PHOTONIC WAFER-SCALE INTERPOSER WITH OPTICAL LINKS BASED ON QUANTUM DOT VCSELS

(71) Applicant: Volantis Semiconductor, Inc., Portland, OR (US)

(72) Inventors: Tapabrata Ghosh, San Francisco, CA (US); John Sonkoly, Boise, ID (US)

(73) Assignee: Volantis Semiconductor, Inc., Portland, OR (US)

(21) Appl. No.: 19/290,530

(22) Filed: Aug. 5, 2025

Related U.S. Application Data
(63) Continuation-in-part of application No. 19/289,269, filed on Aug. 4, 2025.
(63) Continuation-in-part of application No. 19/260,549, filed on Jul. 6, 2025.
Application No. 19/260,549 is a continuation-in-part of application No. 19/260,471, filed on Jul. 5, 2025.
Application No. 19/260,471 is a continuation-in-part of application No. 19/243,462, filed on Jun. 19, 2025.
Application No. 19/243,462 is a continuation-in-part of application No. 19/235,870, filed on Jun. 12, 2025.
Application No. 19/235,870 is a continuation-in-part of application No. 19/230,233, filed on Jun. 6, 2025.
Application No. 19/230,233 is a continuation-in-part of application No. 19/223,614, filed on May 30, 2025.
Application No. 19/223,614 is a continuation-in-part of application No. 19/222,606, filed on May 29, 2025.
Application No. 19/222,606 is a continuation-in-part of application No. 19/211,446, filed on May 19, 2025.
Application No. 19/211,446 is a continuation-in-part of application No. 19/210,116, filed on May 16, 2025.
Application No. 19/210,116 is a continuation-in-part of application No. 19/192,587, filed on Apr. 29, 2025.
Application No. 19/192,587 is a continuation-in-part of application No. 19/192,146, filed on Apr. 28, 2025.
Application No. 19/192,146 is a continuation-in-part of application No. 19/189,471, filed on Apr. 25, 2025.
Application No. 19/189,471 is a continuation-in-part of application No. 19/188,057, filed on Apr. 24, 2025.
Application No. 19/188,057 is a continuation-in-part of application No. 19/177,834, filed on Apr. 14, 2025.
Application No. 19/177,834 is a continuation-in-part of application No. 19/093,546, filed on Mar. 28, 2025.
Application No. 19/093,546 is a continuation-in-part of application No. 19/079,851, filed on Mar. 14, 2025.
Application No. 19/079,851 is a continuation-in-part of application No. 19/056,456, filed on Feb. 18, 2025.
Application No. 19/056,456 is a continuation-in-part of application No. 19/023,647, filed on Jan. 16, 2025.
Application No. 19/023,647 is a continuation-in-part of application No. 18/978,188, filed on Dec. 12, 2024.
Application No. 18/978,188 is a continuation-in-part of application No. 18/958,107, filed on Nov. 25, 2024.
Application No. 18/958,107 is a continuation-in-part of application No. 18/940,944, filed on Nov. 8, 2024.
(60) Provisional application No. 63/714,353, filed on Oct. 31, 2024.
(60) Provisional application No. 63/720,216, filed on Nov. 14, 2024.
(60) Provisional application No. 63/750,817, filed on Jan. 29, 2025.
(60) Provisional application No. 63/750,822, filed on Jan. 29, 2025.

(51) Int. Cl. H04B 10/50; H04B 10/70

(52) U.S. Cl. CPC H04B 10/503; H04B 10/70

(57) ABSTRACT

A plurality of circuits and a plurality of quantum dot vertical-cavity surface-emitting lasers (QD-VCSELs) are bonded to a front side of a directly modulated photonic wafer-scale interposer (PWSI). The PWSI includes a plurality of waveguides. Electrical data is sent by a first circuit within the plurality of circuits to a QD-VCSEL. A degree of freedom (DoF) of a light beam emitted by the QD-VCSEL is modulated. The degree of freedom can include intensity, polarization, mode, wavelength, and so on. The emitted light beam comprises a degree of freedom modulated beam (DFMB) based on the electrical data that was sent. The DFMB is coupled optically to a waveguide. The waveguide is further coupled to an optical decoding element. The DFMB is decoded by the optical decoding element into the electrical data. The electrical data that was decoded is delivered to a second circuit.

### RELATED APPLICATIONS

This application is a continuation-in-part of U.S. patent application “Optical Links On A Directly Modulated Photonic Wafer-Scale Interposer With Oxide-Free VCSELS” Ser. No. 19/289,269, filed Aug. 4, 2025.

The U.S. patent application: “Optical Links On A Directly Modulated Photonic Wafer-Scale Interposer With Oxide-Free VCSELS” Ser. No. 19/289,269, filed Aug. 4, 2025, is also a continuation-in-part of U.S. patent application “Dynamic Redundancy With Parallel Optical Links”Ser. No. 19/260,549, filed Jul. 6, 2025.

The U.S. patent application “Dynamic Redundancy With Parallel Optical Links” Ser. No. 19/260,549, filed Jul. 6, 2025, is also a continuation-in-part of U.S. patent application “Reduction Of Waveguide Crosstalk With Sub-Wavelength Structures” Ser. No. 19/260,471, filed Jul. 5, 2025.

The U.S. patent application “Reduction Of Waveguide Crosstalk With Sub-Wavelength Structures” Ser. No. 19/260,471, filed Jul. 5, 2025, is also a continuation-in-part of U.S. patent application “Disaggregated Memory Structures On A Directly Modulated Photonic Wafer-Scale Interposer”Ser. No. 19/243,462, filed Jun. 19, 2025.

The U.S. patent application “Disaggregated Memory Structures On A Directly Modulated Photonic Wafer-Scale Interposer” Ser. No. 19/243,462, filed Jun. 19, 2025, is also a continuation-in-part of U.S. patent application “Optical Links With Degree Of Freedom VCSEL Modulation On A Photonic Wafer-Scale Interposer”Ser. No. 19/235,870, filed Jun. 12, 2025.

The U.S. patent application “Optical Links With Degree Of Freedom VCSEL Modulation On A Photonic Wafer-Scale Interposer” Ser. No. 19/235,870, filed Jun. 12, 2025, is also a continuation-in-part of U.S. patent application “Optical Link With VCSEL Wavelength Modulation”Ser. No. 19/230,233, filed Jun. 6, 2025.

The U.S. patent application “Optical Link With VCSEL Wavelength Modulation” Ser. No. 19/230,233, filed Jun. 6, 2025, is also a continuation-in-part of U.S. patent application “Optical Link With Modulation Of VCSEL Modes” Ser. No. 19/223,614, filed May 30, 2025.

The U.S. patent application “Optical Link With Modulation Of VCSEL Modes” Ser. No. 19/223,614, filed May 30, 2025, is also a continuation-in part of U.S. patent application “Optical Link With Polarization-Switched VCSEL Modulation” Ser. No. 19/222,606, filed May 29, 2025.

The U.S. patent application “Optical Link With Polarization-Switched VCSEL Modulation” Ser. No. 19/222,606, filed May 29, 2025, is also a continuation-in-part of U.S. patent application “Hierarchical Redundancy With Parallel Optical Links” Ser. No. 19/211,446, filed May 19, 2025.

The U.S. patent application “Hierarchical Redundancy With Parallel Optical Links” Ser. No. 19/211,446, filed May 19, 2025, is also a continuation-in-part of U.S. patent application “Waveguides Based On Nanoimprint Lithography On A Photonic Wafer Scale Interposer”Ser. No. 19/210,116, filed May 16, 2025.

The U.S. patent application “Waveguides Based On Nanoimprint Lithography On A Photonic Wafer Scale Interposer” Ser. No. 19/210,116, filed May 16, 2025, is also a continuation-in-part of U.S. patent application “Photonic Wafer-Scale Interposer With Mirrors Based on Nanoimprint Lithography”Ser. No. 19/192,587, filed Apr. 29, 2025.

The U.S. patent application “Photonic Wafer-Scale Interposer With Mirrors Based on Nanoimprint Lithography” Ser. No. 19/192,587, filed Apr. 29, 2025, is also continuation-in-part of U.S. patent application “Photonic Wafer-Scale Interposer With Micro Transfer Printed VCSELS And Back Side Power Delivery” Ser. No. 19/192,146, filed Apr. 28, 2025.

The U.S. patent application “Photonic Wafer-Scale Interposer With Micro Transfer Printed VCSELS And Back Side Power Delivery” Ser. No. 19/192,146, filed Apr. 28, 2025, is also a continuation-in-part of U.S. patent application “Photonic Wafer Scale Interposer With Integrated Crystallographic Etched Mirrors And Pre-Angled Light” Ser. No. 19/189,471, filed Apr. 25, 2025.

The U.S. patent application “Photonic Wafer Scale Interposer With Integrated Crystallographic Etched Mirrors And Pre-Angled Light” Ser. No. 19/189,471, filed Apr. 25, 2025, is also a continuation-in-part of U.S. patent application “Photonic Wafer Scale Interposer With Angled Beam Grating Couplers” Ser. No. 19/188,057, filed Apr. 24, 2025.

The U.S. patent application “Photonic Wafer Scale Interposer With Angled Beam Grating Couplers” Ser. No. 19/188,057, filed Apr. 24, 2025, is also a continuation-in-part of U.S. patent application “Back Side Power Delivery For Wafer-Scale Integration With An Isometric Grid Array With Compression Pins”Ser. No. 19/177,834, filed Apr. 14, 2025.

The U.S. patent application “Back Side Power Delivery For Wafer-Scale Integration With An Isometric Grid Array With Compression Pins” Ser. No. 19/177,834, filed Apr. 14, 2025, is also a continuation-in-part of U.S. patent application “Back Side Power Delivery For Wafer-Scale Integration With Laser Assisted Bonding” Ser. No. 19/093,546, filed Mar. 28, 2025.

The U.S. patent application “Back Side Power Delivery For Wafer-Scale Integration With Laser Assisted Bonding” Ser. No. 19/093,546, filed Mar. 28, 2025, is also a continuation-in-part of U.S. patent application “Photonic Wafer-Scale Interposer With Tapered Waveguides”Ser. No. 19/079,851, filed Mar. 14, 2025.

The U.S. patent application “Photonic Wafer-Scale Interposer With Tapered Waveguides” Ser. No. 19/079,851, filed Mar. 14, 2025, is also a continuation-in-part of U.S. patent application “Back Side Power Delivery For Wafer-Scale Integration With An Isometric Grid Compression Plate” Ser. No. 19/056,456, filed Feb. 18, 2025, which claims the benefit of U.S. provisional patent applications “Chiplet-Based Optical Wafer-Scale Network Switch” Ser. No. 63/750,817, filed Jan. 29, 2025, and “Wafer-Scale Integration Power Delivery With An Isotropic Conductive Adhesive”Ser. No. 63/750,822, filed Jan. 29, 2025.

The U.S. patent application “Back Side Power Delivery For Wafer-Scale Integration With An Isometric Grid Compression Plate” Ser. No. 19/056,456, filed Feb. 18, 2025, is also a continuation-in-part of U.S. patent application “Back Side Power Delivery For Wafer-Scale Integration With Solderless Modular Power Substrates” Ser. No. 19/023,647, filed Jan. 16, 2025, which claims the benefit of U.S. provisional patent applications “Cooling For Wafer-Scale Integration With Back Side Power Coupling” Ser. No. 63/714,353, filed Oct. 31, 2024, and “Back Side Wafer-Scale Power Delivery With An Anisotropic Conductive Film” Ser. No. 63/720,216, filed Nov. 14, 2024.

The U.S. patent application “Back Side Power Delivery For Wafer-Scale Integration With Solderless Modular Power Substrates” Ser. No. 19/023,647, filed Jan. 16, 2025, is also a continuation-in-part of U.S. patent application “Wafer-Scale Integration With A Stiffening Isometric Grid Array” Ser. No. 18/978,188, filed Dec. 12, 2024, which claims the benefit of U.S. provisional patent applications “Cooling for Wafer-Scale Integration With Back Side Power Coupling” Ser. No. 63/714,353, filed Oct. 31, 2024, and “Back Side Wafer-Scale Power Delivery With An Anisotropic Conductive Film” Ser. No. 63/720,216, filed Nov. 14, 2024.

The U.S. patent application “Wafer-Scale Integration With A Stiffening Isometric Grid Array” Ser. No. 18/978,188, filed Dec. 12, 2024, is also a continuation-in-part of U.S. patent application “Cold Plate Cooling For Wafer-Scale Integration With Back Side Modular Power Delivery” Ser. No. 18/958,107, filed Nov. 25, 2024, which claims the benefit of U.S. provisional patent applications “Cooling for Wafer-Scale Integration With Back Side Power Coupling” Ser. No. 63/714,353, filed Oct. 31, 2024, and “Back Side Wafer-Scale Power Delivery With An Anisotropic Conductive Film”Ser. No. 63/720,216, filed Nov. 14, 2024.

The U.S. patent application “Cold Plate Cooling For Wafer-Scale Integration With Back Side Modular Power Delivery” Ser. No. 18/958,107, filed Nov. 25, 2024, is also a continuation-in-part of U.S. patent application “Back Side Wafer-Scale Integration With Modular Power Delivery” Ser. No. 18/940,944, filed Nov. 8, 2024, which claims the benefit of U.S. provisional patent application “Cooling for Wafer-Scale Integration With Back Side Power Coupling”Ser. No. 63/714,353, filed Oct. 31, 2024.

Each of the foregoing applications is hereby incorporated by reference in its entirety.

### FIELD OF ART

This application relates generally to transmitting data and more particularly to a directly modulated photonic wafer-scale interposer with optical links based on quantum dot VCSELs.

### BACKGROUND

We are always acquiring, storing, processing and evaluating information, whether we are consciously aware of it or not. For example, our bodies receive and process information all the time, both consciously and unconsciously. We take in information such as visual data, sounds, and smells through our senses and use it to understand our surroundings, navigate through them, and make decisions. We store information throughout our body in the form of DNA, proteins, and signaling chemicals. We store information in our brains through a complex, and not fully understood, system of neurons. Information can also be shared. Humans long ago learned how to store information in other forms, outside their bodies. We can communicate information to other humans via sounds, signals, and gestures. This results in the information being transferred—perhaps imperfectly—and subsequently stored and processed by the other human. A long history of oral tradition in many cultures preserved vast amounts of information using the media of human minds and voices. People also discovered that technology could assist in information transfer and storage. Markers could be placed on a trail to show others the best paths to take. Symbols could be drawn in the dirt to more clearly demonstrate a concept to another human. Eventually, humans developed systems of writing that could store information in more durable media including wood, paint, cloth, stone, and metal. These advances increased the longevity, portability, and reliability of information storage for many applications. A letter could be written in one city, brought to another city, and read verbatim to thousands. Words could be carved in stone or etched in metal, lending them increased permanence and figurative, as well as literal, weight. We have written records today that have survived long after those that wrote them, and anyone else who knew the information, were long deceased.

As the years progressed, humans made greater advances in information storage and transfer technology. Materials that were easier to manufacture and write on, written languages that could convey more nuances of speech, and mathematics were all early developments. Later technologies brought the ability to transfer more information, and over longer distances. Organizational achievements such as postal networks, and technological advances like thinner paper and the printing press, increased information density, speed, and range. Eventually, even more complex technologies emerged including the telegraph, radio, and analog and digital storage. In modern times the volume, speed, and density of information have increased rapidly. Humans create and transmit more information now than at any other time in history, and with this change comes the demand for even faster, more efficient, and more reliable technologies for sending, storing, and processing this information.

### SUMMARY

Many technological advances in the modern era require massive amounts of computing power. Digital simulations, genome sequencing, datacenter management, and high-speed communications, to name just a few of the many applications, all require processors that can perform rapid operations. The growth of artificial intelligence (AI) systems is also driving an increase in demand for more powerful computing systems. Even with large numbers of the fastest processors, training the latest AI models can take months, and in a highly competitive field, any advantage in speed can make a difference. Processing speed alone, however, is not the only factor in the overall performance of a computer system. Computer systems have many components, and these components must communicate with one another to perform tasks. For example, if the speed of communication between the memory and processor does not match the speed at which the processor can perform operations, the overall speed of the system is not increased. The latency, bandwidth, and power consumption of communication systems all factor into the system performance. Advances in these areas have greatly improved the capabilities of computing systems in the past, and will continue to do so as further advances are made.

Disclosed techniques enable improved data transmissions. A plurality of circuits and a plurality of quantum dot vertical-cavity surface-emitting lasers (QD-VCSELs) are bonded to a front side of a directly modulated photonic wafer-scale interposer (PWSI). The PWSI includes a plurality of waveguides. Electrical data is sent by a first circuit within the plurality of circuits to a QD-VCSEL. A degree of freedom (DoF) of a light beam emitted by the QD-VCSEL is modulated. The degree of freedom can include intensity, polarization, mode, wavelength, and so on. The emitted light beam comprises a degree of freedom modulated beam (DFMB) based on the electrical data that was sent. The DFMB is coupled optically to a waveguide. The waveguide is further coupled to an optical decoding element. The DFMB is decoded by the optical decoding element into the electrical data. The electrical data that was decoded is delivered to a second circuit.

A method for transmitting data is disclosed comprising: bonding, to a front side of a directly modulated photonic wafer-scale interposer (PWSI), a plurality of circuits and a plurality of quantum dot vertical-cavity surface-emitting lasers (QD-VCSELs), wherein the PWSI includes a plurality of waveguides; sending electrical data, by a first circuit within the plurality of circuits, to a QD-VCSEL within the plurality of QD-VCSELs; modulating a degree of freedom (DoF) of a light beam emitted by the QD-VCSEL, wherein the emitted light beam comprises a degree of freedom modulated beam (DFMB), wherein the DFMB is based on the electrical data that was sent; coupling optically the DFMB to a waveguide within the plurality of waveguides, wherein the waveguide is further coupled to an optical decoding element; decoding, by the optical decoding element, the DFMB into the electrical data; and delivering the electrical data that was decoded to a second circuit within the plurality of circuits.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for a directly modulated photonic wafer-scale interposer with optical links based on quantum dot VCSELS (QD-VCSELs).

FIG. 2 is a flow diagram for modulating a degree of freedom of a QD-VCSEL.

FIG. 3 is an example of a QD-VCSEL.

FIG. 4 is a block diagram of an optical link with QD-VCSEL modulation.

FIG. 5 is a diagram for asymmetric current injection for polarization modulation.

FIG. 6 is a diagram of transverse electromagnetic (TEM) modes.

FIG. 7 is an apparatus for a directly modulated photonic wafer-scale interposer with optical links based on quantum dot VCSELS (QD-VCSELs).

FIG. 8 is a system diagram for a directly modulated photonic wafer-scale interposer with optical links based on quantum dot VCSELS (QD-VCSELs)

### DETAILED DESCRIPTION

Techniques for transmitting data using a directly modulated photonic wafer-scale interposer with optical links based on quantum dot VCSELS are disclosed. Today's demand for ever-increasing processing performance has strained the capabilities of even the most advanced computer systems. Many technological applications require vast amounts of processing power, including weather and climate modeling, genomics and bioinformatics, computational fluid dynamics, materials science simulation, and artificial intelligence (AI). To attempt to meet these demands, systems-on-chip (SoCs) have been designed that integrate previously disparate components into a single chip. Such components can include processors, memory, input/output interfaces, switching elements, and others. SoCs can have improved performance, cost-effectiveness, power efficiency, and economy of design over traditional multi-chip systems. Other hardware has been developed to meet these demands as well. For example, to improve the performance of AI models, AI accelerator chips have been specially designed to excel at tasks required by AI models including parallel processing and matrix operations. Today's large language models (LLMs) rely on these AI accelerators to achieve their high levels of performance.

In order to improve processing performance, much attention has also been devoted to improvements in the field of system interconnects between chips. Technologies like high bandwidth memory (HBM), where memory can be stacked vertically as well as grouped horizontally, allow for rapid memory access. Multi-core processors and advancements in multi-threading techniques allow processors to perform operations faster than ever before. But while memory density and processor speed have advanced rapidly, inter-component communication has not kept pace. This means that systems can stall when the data required by the processor is not delivered quickly enough, forcing the processor to wait. Thus, valuable processor cycles and memory capacity are often under-utilized. One promising technology to help bridge this gap is optical communication. Optical communication can have lower power usage and higher bandwidth than wire interconnects. Another area of recent advancement is in wafer-scale integration (WSI). In one implementation of WSI, a single silicon wafer is used as an interposer for multiple chips or SoCs, improving system performance.

Optical technologies can also improve communication speed and bandwidth. For example, vertical-cavity surface-emitting lasers (VCSELs) can be fabricated to emit a beam of light that can be modulated to carry a signal between components on a chip, wafer, or multi-chip system. VCSELs can enable lower latency and higher bandwidth communications than metal wires, especially over long (on chip-scale) distances. VCSELs can be manufactured in large quantities in two-dimensional arrays on a single chip and thus can be cost effective. However, VCSELs are not without disadvantages. VCSELs often use a quantum well structure to comprise the active region, performing lasing action when applied current is above a threshold. Quantum well VCSELs provide good gain characteristics, though carrier confinement is not limited in three dimensions. Thus, carrier leakage and non-radiative recombination can occur, reducing efficiency especially at higher temperatures. Thus, a quantum well VCSEL can include a higher than desired threshold voltage in some conditions, leading to higher power consumption for some modulation techniques. To address these issues, directly modulated photonic wafer-scale interposers with optical links based on quantum dot VCSELs are disclosed. A QD-VCSEL can utilize a quantum dot structure which can provide confinement in three-dimensions, thus lowering carrier leakage and non-radiative recombination. As a result, QD-VCSELs can operate at a lower threshold current, leading to better performance.

A plurality of circuits and a plurality of QD-VCSELs are bonded to a front side of a directly modulated photonic wafer-scale interposer (PWSI). The PWSI further includes a plurality of waveguides that can be used for transmitting data. Electrical data is sent by a first circuit to a quantum dot vertical-cavity surface-emitting laser (QD-VCSEL). The first circuit can be a chiplet, an SoC, a wafer, an ASIC, a core, a core on a wafer, and so on. The first circuit can be a circuit within a chip, a chiplet, a system-on-chip (SoC), a wafer, etc. A degree of freedom of the QD-VCSEL is modulated. The degree of freedom can include an intensity of light, a polarization of light, a light mode, a light wavelength, and so on. The QD-VCSEL emits a degree of freedom modulated beam (DFMB). The DFMB is based on the electrical data that was sent. The DFMB is coupled optically to a waveguide. The DFMB can be coupled optically to other optical media such as an optical fiber. The coupling optically can be accomplished by a mirror, such as a TMAH-etched mirror, a grating coupler, and so on. The coupling can include angling the DFMB that was emitted by the QD-VCSEL. The angling can be based on a micro-optical element (MOE) such as a micro lens, a diffractive optical element, a Fresnel lens, an asymmetric non-focusing optical device, and so on.

The waveguide is further coupled to an optical decoding element (ODE). The ODE can comprise a grating coupler, a polarization filter, a polarization multiplexor (PMUX), and so on. The ODE decodes the DFMB into the electrical data. In the case of a PMUX, a polarized beam splitter (PBS) can separate the DFMB into at least two polarized optical signals. The PBS can be within the PMUX. The separating can be based on a plane of polarization of the polarization-modulated beam (PMB). Each polarized optical signal, optical mode, or optical wavelength can be transformed by a unique photodiode. The transforming can result in at least two electrical signals. These electrical signals can be assembled into a single electrical signal.

The single electrical signal can comprise the electrical data that was sent. The electrical data that was decoded is delivered to a second circuit, which can be a chiplet, an SoC, a wafer, an ASIC, a core, a core on a wafer, and so on. The second circuit can comprise a circuit within a chip, a chiplet, an SoC, a wafer, etc. The first chiplet, the second chiplet, and the QD-VCSEL can be within a plurality of chiplets bonded to a front side of a directly modulated photonic wafer-scale interposer (PWSI). The PWSI can include a plurality of waveguides. The waveguide can comprise a waveguide within the plurality of waveguides. Other optical media can be used. The optical medium can include an optical fiber.

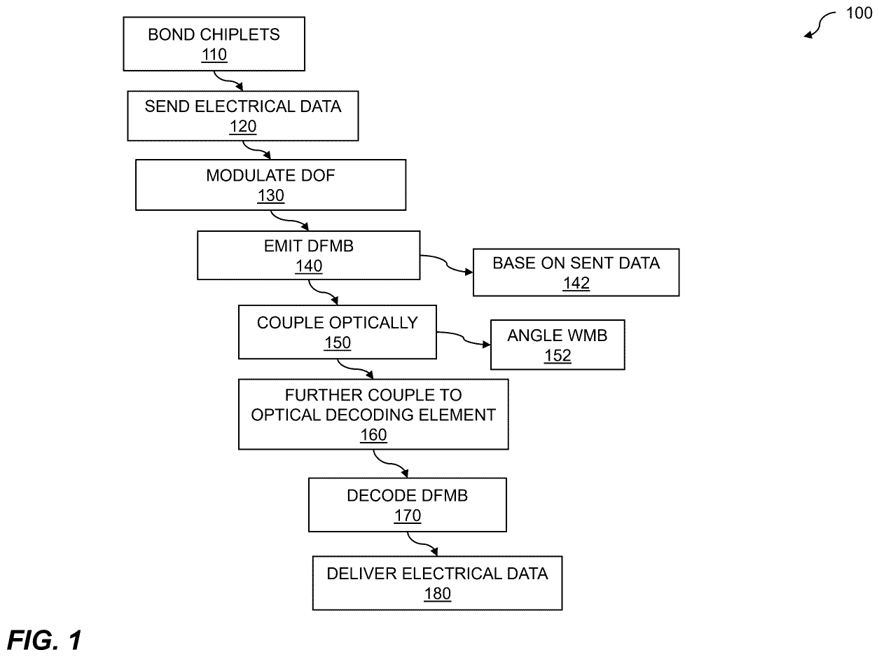

FIG. 1 is a flow diagram for a directly modulated photonic wafer-scale interposer with optical links based on quantum dot VCSELS (QD-VCSELs). The flow 100 includes bonding chiplets 110. Embodiments include bonding, to a front side of a directly modulated photonic wafer-scale interposer (PWSI), a plurality of circuits and a plurality of quantum dot vertical-cavity surface-emitting lasers (QD-VCSELs), wherein the PWSI includes a plurality of waveguides. The plurality of circuits can include chiplets that perform a variety of functions such as artificial intelligence (AI) acceleration, switching, data processing of various data types, and so on. The plurality of circuits can include memory such as high bandwidth memory (HBM), cores such as processor cores, cores fabricated on or coupled to a wafer, an interposer, and the like. The PWSI includes a plurality of waveguides. The waveguides can be used to transmit data between circuits. The circuits can be separated by a long distance on the PWSI. In some embodiments, at least one waveguide in the plurality of waveguides comprises a first distance, wherein the first distance is greater than an exposure, on the PWSI, of a single photomask reticle. In some embodiments, the at least one waveguide is fabricated using a nanoimprint lithography (NIL) process. To accommodate longer paths, the waveguides can be manufactured via another suitable fabrication technology such as reticle stitching.

The flow 100 includes sending electrical data 120. Embodiments include sending electrical data, by a first circuit within the plurality of circuits, to a QD-VCSEL within the plurality of QD-VCSELs. The first circuit can be a circuit within a chip, a core, a chiplet, an SoC, a wafer, an interposer, etc. As described above, the first circuit can comprise a processor, a multi-core processor, a memory controller, a memory chip such as double data rate (DDR) or high bandwidth memory (HBM), an input/output (I/O) chip, an AI accelerator, a switching chip, a chiplet, and so on. The first circuit can further comprise a core, a core on (or manufactured within) a wafer, etc. The first circuit and the QD-VCSEL can be on the same or different circuit boards, interposers, wafers, etc. Noted previously, the first circuit and the QD-VCSEL can be bonded to a front side of the photonic wafer-scale interposer. The sending can be accomplished using any means to communicate between chips. For example, the sending can be based on a routes on a printed circuit board, a bus interface, a wireless communication protocol such as Bluetooth™, metal layers on a wafer or a wafer interposer, and so on. The electrical data can comprise serialized data, data packets, handshaking signals, etc.

A QD-VCSEL can be a semiconductor laser which can be fabricated on a chip. The QD-VCSEL can comprise a QD-VCSEL array. The QD-VCSEL array can include a plurality of QD-VCSELs. The fabrication can be based on gallium arsenide or another suitable material. In some embodiments, a substrate associated with each QD-VCSEL within the plurality of QD-VCSELs comprises gallium arsenide (GaAs). The QD-VCSEL can emit light in a direction perpendicular to the chip. The direction can be up (e.g., away from the chip) or down (e.g., into the chip). When light is emitted down, a window can be provided so that the light can escape through the back of the chip. To aid projection of the light, the substrate of the chip can be thinned. The light that is emitted can be coherent light that is in a wavelength range, such as 850 nm-950 nm. Other ranges are possible. QD-VCSELs can include quantum dots. In embodiments, each QD-VCSEL within the plurality of QD-VCSELs includes one or more quantum dots within an active region, wherein the one or more quantum dots confine a plurality of carriers in three dimensions. A quantum dot can comprise a semiconductor particle that can exhibit behavior similar to that of an individual atom (e.g., discrete atomic energy levels). Since the confinement can be different from a quantum well VCSEL, a QD-VCSEL can exhibit better electrical characteristics such as lower threshold current, sharper gain spectrum, better temperature sensitivity, and so on. Quantum dots can be manufactured to emit specific wavelengths of light by modifying various properties of the quantum dots including shape, size, and transparency.

The flow 100 includes modulating a degree of freedom (DoF) of light 130. Embodiments include modulating a degree of freedom (DoF) of a light beam emitted by the QD-VCSEL, wherein the emitted light beam comprises a degree of freedom modulated beam (DFMB), wherein the DFMB is based on the electrical data that was sent. The modulating a degree of freedom can include modulating an intensity of the QD-VCSEL, modulating a polarization of the QD-VCSEL, modulating a mode of the QD-VCSEL, modulating a wavelength of the QD-VCSEL, and so on. The modulating a property of the light causes the QD-VCSEL to emit a light beam based on the degree of freedom. The resulting emitted light beam comprises a degree of freedom modulated beam (DFMB). The DFMB can include one or more of a polarization of light, a mode of light, a wavelength of light, an intensity of light, etc. The DFMB is based on the electrical data that was sent. The modulation can include adjusting properties of light emission of the QD-VCSEL to encode optical data. The modulation can also include changing a degree of freedom, during transmission, of the light emitted by the QD-VCSEL. The modulating can be based on multiplexing techniques such as a time division multiplexing (TDM) technique. The TDM technique can enable sending of multiple degree of freedom signals by assigning a time slot to each degree of freedom signal.

In some embodiments, the degree of freedom comprises an intensity of the QD-VCSEL. For example, the modulation can be based on current. Adjusting the current applied to an active region of the QD-VCSEL can turn light emission on/off or change the intensity of the emitted light. When the current is below a threshold, lasing action can be stopped. When current levels return to a level exceeding the threshold, lasing can restart. As current is increased, a brightness, or optical power, of the QD-VCSEL can be increased. The detection of a presence or absence of light from the QD-VCSEL can be used to encode a “1” or “0” in the form of a light wave. The intensity of the QD-VCSEL can be modulated by adjusting current to the QD-VCSEL. The current can be adjusted above and below the threshold to enable or disable lasing, respectively. Alternatively, the modulating can include increasing and decreasing current to increase and decrease intensity, respectively. The increase or decrease in intensity can also be interpreted as a “1” or “0.”

In some embodiments, the degree of freedom comprises a polarization of the QD-VCSEL. Polarization can refer to an orientation of an oscillating light wave. The polarization can include linear polarization, circular polarization, elliptical polarization, etc. In some embodiments, the modulation is based on asymmetric current injection. The polarization can be controlled by asymmetric current injection. Asymmetric current injection can include sending current into an active region of the QD-VCSEL in a non-uniform way. The non-uniformity can influence the QD-VCSEL to produce polarized light in a first direction. The applied current can be altered to produce polarized light in a second direction. The asymmetric current injection can include a current with a DC offset, a current that includes an asymmetric wave, and the like.

Polarization of light emitted from the QD-VCSEL can also be accomplished with a ferroelectric liquid crystal layer. In some embodiments, the QD-VCSEL includes a ferroelectric liquid crystal layer (FLC). The FLC can include liquid crystals that can be oriented by an electric field.

Applying a voltage to the FLC can also influence the polarization of light emitted by the QD-VCSEL. The FLC can include a bottom and middle Distributed Bragg Reflector (DBR) with the FLC layer on top of the middle layer. A top DBR can be included on top of the FLC layer. Other layouts are possible.

In some embodiments, the degree of freedom comprises a mode of the QD-VCSEL. The degree of freedom can include a mode such a transverse electromagnetic (TEM) mode. A TEM can indicate a distribution of the electrical field emitted from the QD-VCSEL in a plane perpendicular to the direction of the emission. In a usage example, the TEM mode can include TEM₀₀, TEM₁₀, and TEM₀₁, and so on. The TEM modes can include a fundamental mode, a low order mode, a high order mode, and so on. In some embodiments, a fundamental mode of the QD-VCSEL comprises a higher order mode than a non-fundamental mode. The mode of the QD-VCSEL can be changed by altering current. In some embodiments, the modulating comprises altering current to the QD-VCSEL. In some embodiments, the QD-VCSEL comprises a multimodal QD-VCSEL. A multimodal QD-VCSEL can support a plurality of modes which can be altered by the modulating. A logic “1” can be assigned to a first mode while a logic “0” can be assigned to a second mode. In this way, optical data can be encoded and decoded.

In some embodiments, the degree of freedom comprises a wavelength of the QD-VCSEL. That is, the degree of freedom can include a wavelength of light emitted from the QD-VCSEL. The wavelength can be modulated based on current injection. In some embodiments, the modulating comprises injecting current into the QD-VCSEL. The injecting current can enable degree of freedom modulation based on wavelength of light. The injecting current can affect the wavelength emitted by the QD-VCSEL by changing a density of carriers within the active area. In some embodiments, the modulating is based on QD-VCSEL chirp. QD-VCSEL chirp can refer to a change in emission wavelength of a QD-VCSEL due to injecting current, changing current, varying current, etc. The wavelength can also be modulated by altering a bias current to the QD-VCSEL. In some embodiments, the injecting includes altering a bias current to the QD-VCSEL.

The flow 100 includes emitting a degree of freedom modulated beam (DFMB) 140. Modulation such as described above can be used to encode optical data. Noted above, the modulating causes the QD-VCSEL to emit a light beam which can result from modulating an intensity of the light, a plane of polarization of the light, a mode of the light, a wavelength of the light, etc. The DFMB can comprise an optical signal whose degree of freedom changes over time, thus encoding optical information. The degree of freedom of the beam can be sensed, allowing for the decoding of the information that is sent. Recall that electrical data is sent by a first circuit to a QD-VCSEL. The electrical data can be used to modulate a degree of freedom of the QD-VCSEL by disclosed techniques, resulting in a DFMB sent from the QD-VCSEL. Thus, in the flow 100, the DFMB is based on the electrical data that was sent 142.

The flow 100 includes coupling optically 150. Embodiments include coupling optically the DFMB to a waveguide within the plurality of waveguides, wherein the waveguide is further coupled to an optical decoding element. The waveguide can include a waveguide within a wafer, an interposer, and so on. Other optical mediums can be used. An optical medium can be any material, space, etc. that allows an optical signal, such as a DFMB, to propagate. The DFMB can be coupled optically to other optical media such as an optical fiber. In a usage example, the optical medium comprises a degree of freedom maintaining fiber. The degree of freedom can include a polarization of light, a light mode, a light wavelength, etc. The degree of freedom maintaining fiber can maintain fidelity of the DFMB. The first circuit and the QD-VCSEL can be bonded to a photonic wafer-scale interposer (PWSI) which includes a plurality of waveguides to carry optical signals from one or more QD-VCSELs. The optical medium can comprise a waveguide within the plurality of waveguides. Recall that the QD-VCSEL can emit optical signals, such as the DFMB, in a vertical direction. The vertical direction can be down, toward the substrate (and the PWSI to which a QD-VCSEL can be bonded). A waveguide within the PWSI can be oriented horizontally or substantially horizontally. Thus, the DFMB can be coupled to the waveguide in order for it to propagate along a waveguide within the PWSI to another circuit bonded to the PWSI, such as a second chiplet.

In some embodiments, the coupling optically is based on a grating coupler. The grating coupler can diffract light at specific frequencies, ranges of frequencies, input angles, ranges of input angles, etc. thereby providing efficient transfer of light at a specific frequency and/or frequencies into or out of a waveguide. To aid the coupling to a grating coupler, the DFMB emitted from the QD-VCSEL can be angled 152. Embodiments include angling the DFMB that was emitted by the QD-VCSEL, wherein the angling is based on a micro-optical element (MOE). The MOE can be based on one or more optical techniques. For example, the MOE can comprise a micro lens. The micro lens can be coupled to the first surface-emitting light source, such as a QD-VCSEL, a laser diode, and so on. The micro lens can pre-angle the emitted light. The MOE can comprise a diffractive optical element. The diffractive optical element can create a light phase profile that can focus, shape, or split the emitted light. The MOE can include a Fresnel lens. The Fresnel lens can use concentric grooves or rings to focus the emitted light. The MOE can include an asymmetric non-focusing optical device. The asymmetric non-focusing optical device can enable light to transmit through the device preferentially, where the light can pass through more easily in one direction than another direction. The asymmetric non-focusing optical device can couple light to a waveguide and can suppress a portion of reflected light back to the surface-emitting light source. Any number and/or types of MOEs can be used in conjunction with any number of QD-VCSELs.

Other methods of coupling the DFMB to the waveguide, or another optical medium such as an optical fiber, can be implemented. The coupling optically can be based on a mirror. The mirror can include a mirror within a circuit, a chip, a wafer, an interposer, and so on. In a usage example, the coupling is based on a crystallographic etched mirror. The crystallographic etched mirror can comprise a tetramethylammonium hydroxide (TMAH) etched mirror. The TMAH mirror can reflect incoming light at substantially a 54.74 degree angle to the waveguide. Other angles are possible with various crystallographic etched mirrors. A crystallographic etched mirror can operate in combination with a MOE, such as described above, which can be placed over or near an aperture of the QD-VCSEL. For example, the MOE can pre-angle light from the QD-VCSEL so that when the light is reflected by the TMAH mirror, it is efficiently coupled directly into the waveguide at 90 degrees, or sufficiently close to 90 degrees, from the light source. The coupling optically can be based on a bent waveguide. The bent waveguide can include a high containment region of a waveguide. The high containment waveguide can redirect the light while minimizing loss of light in the region of the bend of the waveguide. The coupling optically can be based on an off-axis diffractive lens. An off-axis diffractive lens can direct light at an angle with respect to the optical axis of the lens. An off-axis diffractive lens can direct the DVMB at an angle substantially normal to an input aperture of the waveguide into the waveguide.

In the flow 100, the waveguide is further coupled to an optical decoding element (ODE) 160. An ODE can be an optical element that interprets a degree of freedom state of an optical signal. The ODE can be used to decode the DFMB at the far end of the waveguide. The flow 100 includes decoding the DFMB 170. Embodiments include decoding, by the optical decoding element, the DFMB into the electrical data. In a usage example, the DFMB is decoded, by the ODE, into the electrical data that was sent by the first circuit. The ODE can be based on a variety of optical techniques. In some embodiments, the optical decoding element comprises a grating coupler. The grating coupler can separate different polarizations, wavelengths, modes, etc. from each other. In a usage example, the separated polarizations of light can be sent to optical receivers, where the optical receivers can convert the optical data to electrical data. In other embodiments, the optical decoding element comprises a polarization filter. A polarization filter can enable passage of light with a polarization that is compatible with the polarization filter while substantially blocking light with polarizations that are incompatible with the polarization filter. In a usage example, a first polarization filter passes light polarized with a first polarization, and a second polarization filter passes light polarized with a second polarization. In some embodiments, the optical decoding element comprises a polarization multiplexor (PMUX). The PMUX can receive light that includes two or more polarizations. The received light can be separated into two or more beams, where each beam is based on a single polarization (explained in further detail below). The decoding can be based on time-division demultiplexing (TDDM). The TDDM can reassemble two or more signals that were time-multiplexed before sending through the waveguide, optical fiber, etc.

The flow 100 includes delivering electrical data 180. Embodiments include delivering the electrical data that was decoded to a second circuit within the plurality of circuits. The second circuit can comprise a chiplet. As the case with the first circuit, the second circuit can be a circuit within a chip, a core, a chiplet, an SoC, a wafer, an interposer, etc. The second circuit can comprise a processor, a chiplet, a multi-core processor, a memory controller, a memory chip such as DDR or HBM, an I/O chip, an AI accelerator, a switching chip, and so on. In some embodiments, the first circuit and the second circuit comprise a first chiplet and a second chiplet, respectively. The second circuit can further comprise a core, a core on (or manufactured within) a wafer, etc. The second circuit and the first circuit can be on the same or different circuit boards, interposers, wafers, etc. The electrical data can be delivered to the second circuit using a variety of techniques. The delivery techniques can be based on using wire, interconnect, metal layers, and so on. The metal layers can include metal layers within a circuit board, a wafer, an interposer, and so on. The interposer can include a photonic wafer-scale interposer. The metal layers, which enable interconnection between and among circuits, chiplets, and other elements, can be fabricated on or within a circuit board, wafer, or interposer. As was the case for sending the data from the first circuit to the QD-VCSEL, using the metal layers can offer significant inter-chiplet communication speed due to short wire lengths, and reduced “parasitics” such as resistance, capacitance, and inductance. The second circuit can process the delivered data, forward the delivered data, etc.

Various steps in the flow 100 may be changed in order, repeated, omitted, or the like without departing from the disclosed concepts. Various embodiments of the flow 100, or portions thereof, can be included in an apparatus for transmitting data or system that is configured to transmit data.

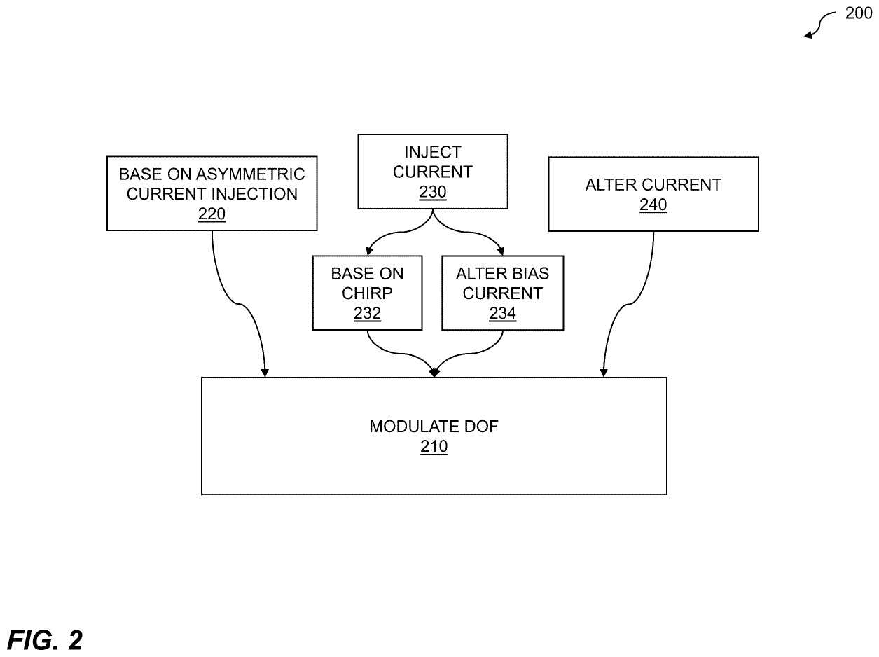

FIG. 2 is a flow diagram for modulating a degree of freedom of a QD-VCSEL. Data is transmitted between a first circuit and a second circuit. The transmitting data is accomplished by sending the data from a first circuit to a first quantum dot vertical-cavity surface-emitting laser (QD-VCSEL). The first circuit and the QD-VCSEL can be bonded to a front side of a photonic wafer-scale interposer (PWSI). The QD-VCSEL emits light that is based on the sent data. The light that is emitted by the QD-VCSEL is a degree of freedom modulated beam (DFMB). The modulating can be based on asymmetric current injection, other current injection, altering current, and so on. The DFMB is coupled optically to an optical medium which transmits the data to an optical decoding element (ODE). The optical medium comprises a waveguide. The optical medium can further comprise an optical fiber. The ODE decodes the DFMB into the electrical data. The decoding can be accomplished by separating the degree of freedom modulated beam. The electrical data that was decoded is delivered to a second circuit. The separating a degree of freedom modulated beam enables a directly modulated photonic wafer-scale interposer with optical links based on quantum dot VCSELs.

The flow 200 includes modulating 210 a degree of freedom (DoF) of light. Embodiments include modulating a degree of freedom (DoF) of a light beam emitted by the QD-VCSEL, wherein the emitted light beam comprises a degree of freedom modulated beam (DFMB), wherein the DFMB is based on the electrical data that was sent. The modulating the light can be based on more than one degree of freedom. In some embodiments, the degree of freedom comprises an intensity of the QD-VCSEL. For example, the modulation can be based on current. Adjusting the current applied to an active region of the QD-VCSEL can turn light emission on/off or change the intensity of the emitted light. When the current is below a threshold, lasing action can be stopped. When current levels return to a level exceeding the threshold, lasing can restart. As current is increased, a brightness, or optical power, of the QD-VCSEL can be increased. The detection of the presence or absence of light from the QD-VCSEL can be used to encode a “1” or “0” in the form of a light wave. The intensity of the QD-VCSEL can be modulated by adjusting current to the QD-VCSEL. The current can be adjusted above and below the threshold to enable or disable lasing, respectively. Alternatively, the modulating can include increasing and decreasing current to increase and decrease intensity, respectively. The increase or decrease in intensity can also be interpreted as a “1” or “0.”

In some embodiments, the degree of freedom comprises a polarization of the QD-VCSEL. The polarization can include an s-polarization and a p-polarization. An s-polarization includes polarization that is normal or perpendicular to a surface of incidence, and a p-polarization includes polarization that is parallel to a surface of incidence. In some embodiments, the modulating is based on asymmetric current injection 220. The polarization can be controlled by asymmetric current injection. Asymmetric current injection can include sending current into an active region of the QD-VCSEL in a non-uniform way. The non-uniformity can influence the QD-VCSEL to produce polarized light in a first direction. The applied current can be altered to produce polarized light in a second direction. For example, more current can be sent to the x-axis of an active region of the QD-VCSEL to produce a polarization in the X plane. The current can be switched to favor the y-axis of the active region of the QD-VCSEL to produce a polarization in the Y plane. Modulation such as described above can be used to encode optical data. The asymmetric current injection can be based on contacts coupled to an active region of the QD-VCSEL. The contacts can include one or more p-contacts and one or more n-contacts. The asymmetric current injection can include a current with a DC offset, a current that includes an asymmetric wave, and the like. The asymmetric current can be based on the data that was sent by the first circuit. The DFMB can include one or more polarizations of light. When more than one polarization of light is present within the DFMB, the polarizations of light can be separated from each other. The separating polarizations of light can be accomplished using an optical decoding element (ODE). The ODE can include a grating coupler, a polarization filter, a polarization multiplexor (PMUX), and so on. The PMUX can comprise various elements to decode a DFMB sent from a polarization-modulated QD-VCSEL through an optical medium such as a waveguide, an optical fiber, etc.

The optical decoding element (ODE) can accomplish the decoding using a polarized beam splitter (PBS). The DFMB can be split into at least two polarized optical signals, where the separating can be based on a plane of polarization of the DFMB. A polarized beam splitter can substantially pass light with a polarization that is compatible with the polarization of the beam splitter and can substantially block light that is incompatible with the polarization of the beam splitter. The PBS can separate the beam based on reflection and transmission of the incoming polarized light. The reflected path and the transmitted path can comprise at least two optical signals. In a usage example, the PBS can direct x-polarized light, which can be called light polarized at 0 degrees, to a transmitted path and direct y-polarized light, which can be called light polarized at 90 degrees, to a reflected path. Other modes of polarization can be used. In another usage example, the polarized beam splitter can pass light that is polarized with an s-polarization and can reflect light that is polarized with a p-polarization. Recall that an s-polarization includes polarization that is normal or perpendicular to a surface of incidence, and a p-polarization includes polarization that is parallel to a surface of incidence. Additional states of polarization can be used in modulation such that the PBS can split the PMB into more than two optical signals. The PBS can be a separate optical element or can be incorporated into another optical element.

In some embodiments, the degree of freedom comprises a wavelength of the QD-VCSEL. The injecting current can enable degree of freedom modulation based on wavelength of light. Thus, in some embodiments, the modulating comprises injecting current 230 into the QD-VCSEL. The injecting current can be accomplished using one or more p-contacts and one or more n-contacts, where the one or more p-contacts and the one or more n-contacts are coupled to the active region of the QD-VCSEL. The injecting current can affect the wavelength emitted by the QD-VCSEL by changing a density of carriers within the active area. In some embodiments, the modulating is based on QD-VCSEL chirp 232. A “chirp,” which can be a temporal change, can cause a change in wavelength of light emitted by a QD-VCSEL. In a usage example, a QD-VCSEL chirp can include a 1 nm to 2 nm change in emitted wavelength. The chirp can be dependent on a variety of QD-VCSEL parameters including dynamic behavior of carrier density in a QD-VCSEL active region, differential gain, etc. The chirp can include a positive change in wavelength or a negative change in wavelength. A bias current of the QD-VCSEL can be altered 234. In some embodiments, the injecting includes altering a bias current to the QD-VCSEL. The altering the bias current can cause a change in the wavelength of the light emitted by the QD-VCSEL by altering a density of carriers within the QD-VCSEL. The change in carrier density can change a refractive index of the QD-VCSEL, and thus the resonance wavelength of the QD-VCSEL. In a second usage example, a higher carrier density reduces the refractive index, thereby shifting the emitted light wavelength toward blue wavelengths. The electrical current can be applied to contacts such as described above.

In some embodiments, the degree of freedom comprises a mode of the QD-VCSEL. In further embodiments, the modulating comprises altering current 240 to the QD-VCSEL. The altering current can enable degrees of freedom based on modes. The modes can include transverse electromagnetic (TEM) modes. As described earlier, a TEM can indicate a distribution of the electrical field emitted from the QD-VCSEL in a plane perpendicular to the direction of the emission. In a usage example, the TEM mode can include TEM₀₀, TEM₁₀, TEM₀₁, and so on. The TEM modes can include a fundamental mode, a low order mode, a high order mode, and so on. In some embodiments, a fundamental mode of the QD-VCSEL comprises a higher order mode than a non-fundamental mode. The altering current can include reversing current direction, varying current magnitude, and so on. In a usage example, the altering current can be based on current injection. Various altered currents can change the mode of the light emitted by the QD-VCSEL. In some embodiments, the QD-VCSEL comprises a multimodal QD-VCSEL. The modes that can be included in the multimodal QD-VCSEL can include fundamental modes, lower order modes, high order modes, and so on. In a usage example, the supported modes can include a fundamental mode such as TEM₀₀. The multimodal QD-VCSEL can support one or more high order transverse modes. In a usage example, the one or more high order transverse modes can include TEM₁₀, or TEM₀₁. Other TEM modes can also be used. The emitted light from the multimodal QD-VCSEL can switch modes based on the altered current.

Various steps in the flow 200 may be changed in order, repeated, omitted, or the like without departing from the disclosed concepts. Various embodiments of the flow 200, or portions thereof, can be included in an apparatus for transmitting data or system that is configured to transmit data.

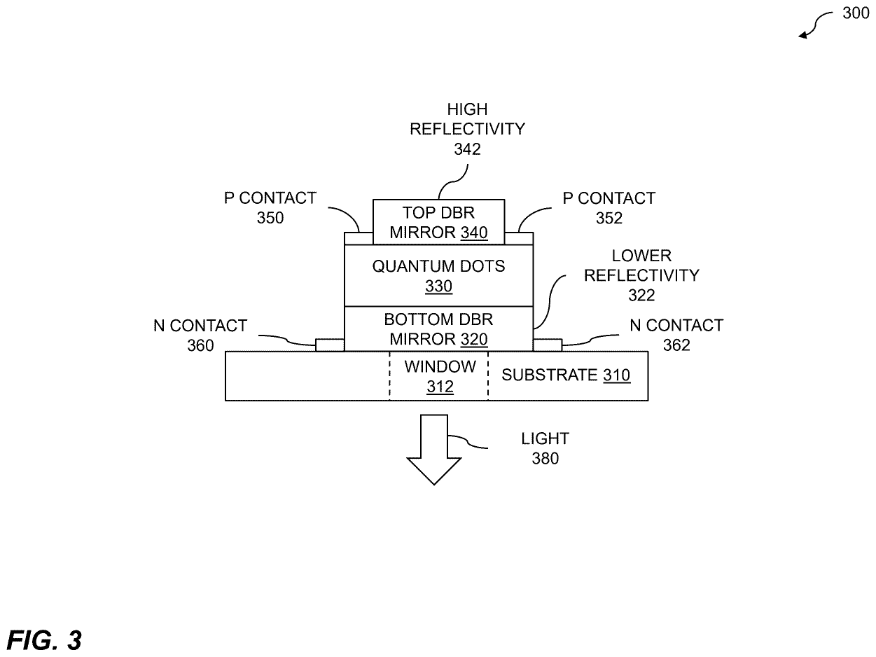

FIG. 3 is an example of a QD-VCSEL. A QD-VCSEL enables a directly modulated photonic wafer-scale interposer with optical links based on quantum dots. A plurality of circuits and a plurality of quantum dot vertical-cavity surface-emitting lasers (QD-VCSELs) are bonded to a front side of a directly modulated photonic wafer-scale interposer (PWSI). The PWSI further includes waveguides for sending data. A first circuit, which can be a first chiplet, sends electrical data. The electrical data is sent to a QD-VCSEL. A degree of freedom (DoF) of the QD-VCSEL is modulated. The modulation causes the QD-VCSEL to emit a degree of freedom modulated beam (DFMB). The DFMB is based on the electrical data that was sent by the first circuit. The DFMB is coupled optically to a waveguide. The coupling optically can be accomplished using a grating coupler, a mirror, and so on. The waveguide is further coupled to an optical decoding element (ODE). The ODE decodes the DFMB into the electrical data. The electrical data that was decoded is delivered to a second circuit, which can be a second chiplet.

The block diagram 300 includes a substrate 310. The substrate can include a variety of materials suitable to fabricating a QD-VCSEL. In some embodiments, a substrate associated with each QD-VCSEL within the plurality of QD-VCSELs comprises gallium arsenide (GaAs). Other materials that can be used for the substrate can include aluminum-gallium-arsenide (AlGaAs), germanium (Ge), sapphire, and so on. The substrate can be thinned to enable fabrication of an aperture or window 312. The thinning of the substrate can be accomplished by grinding, polishing, etching, and so on. Light in the form of a polarization-modulated beam (PMB) is emitted by the QD-VCSEL. The light emitted by the QD-VCSEL can exit the QD-VCSEL by passing through the window in the thinned substrate.

The QD-VCSEL structure comprises quantum dots within an active region which can be placed between two highly reflective mirrors. The first mirror includes a first reflectivity, and the second mirror includes a second reflectivity. In a usage example, the two highly reflective mirrors can be based on Distributed Bragg Reflectors (DBRs). These mirrors can be formed from multiple, alternating layers of materials, where the materials have different refractive indices. In the block diagram 300, a Distributed Bragg Reflector mirror can include a bottom mirror 320. The bottom mirror can include an n-Distributed Bragg Reflector. The bottom mirror can include a reflectivity that is lower than a top mirror (described below). In a usage example, the reflectivity 322 of the bottom DBR can include a reflectivity of 93 percent to 99 percent, or another suitable reflectivity. The n-Distributed Bragg Reflectors associated with the bottom mirror can be insulated from other layers in the block diagram by an oxide layer (not shown).

The block diagram 300 includes quantum dots 330. The quantum dots can be within an active region. In embodiments, each QD-VCSEL within the plurality of QD-VCSELs includes one or more quantum dots within an active region, wherein the one or more quantum dots confine a plurality of carriers in three dimensions. Quantum dots can be semiconductor structures that exhibit behavior similar to individual atoms. The properties of the quantum dots can be modified using various manufacturing techniques including colloidal synthesis, plasma synthesis, electrochemical assembly, high temperature dual injection, and so on. The active region can comprise a region in which light that is emitted by the QD-VCSEL can be generated. The light can be generated using a variety of techniques. In a usage example, the active region can include one or more quantum dots. The quantum dots can confine carriers in three dimensions, which can enable tuning of the wavelength of emitted light. The quantum dots can enable high extinction coefficients and low lasing thresholds of the QD-VCSEL. The active region can be located within a laser cavity. The block diagram 300 can include an additional oxide layer (not shown) between the active region and a top DBR mirror. The oxide layer between the bottom mirror and the active area, and the oxide layer between the active layer and the top mirror, may or may not be present in the QD-VCSEL. Other techniques can be used to form an oxide-free QD-VCSEL such as ion implantation, depositing an out-of-phase gain medium, lithographic patterning, using one or more buried tunnel junctions, using one or more sub-wavelength gratings, using one or more photonic crystals, using regrowth with an etch stop, building one or more mesas, and so on. When present, the oxide layers can confine the light and electrical current within the active area. The block diagram 300 includes a p-Distributed Bragg Reflector mirror 340. The p-Distributed Bragg Reflector mirror comprises the top mirror of the QD-VCSEL. The top mirror can include a high reflectivity 342. In a usage example, the reflectivity of the top DBR can include a reflectivity of 99.4 percent to 99.9 percent. Other suitable reflectivities can be implemented.

An electrical current is applied to the QD-VCSEL to enable the QD-VCSEL to lase in order to emit coherent light. The applied electrical current can include a DC current, a pulsed current, and so on. The current can include a symmetrical current, an asymmetrical current, etc. The applied current can modulate the light emitted by the QD-VCSEL. In some embodiments, modulating is based on asymmetric current injection. An injected asymmetrical current can include a current that is unbalanced or unequal with respect to distribution and/or direction. In a usage example, the current is asymmetrical about the x-axis, that is, the asymmetrical current has a DC offset. The injection of the asymmetrical current can cause the modulated light emitted by the QD-VCSEL to include a polarization. Changing the injected asymmetrical current can change the polarization of the emitted light. The electrical current can be applied to the top p-contact. The p-contact can include a single contact, a ring contact, a “broken ring” contact where the ring is broken into two or more segments, and so on. In the block diagram 300, the contact includes one or more p-contacts such as p-contact 350 and p-contact 352. In some embodiments, the QD-VCSEL includes a ferroelectric liquid crystal layer (FLC). The FLC can include liquid crystals that can be oriented by an electric field. Applying a voltage to the FLC can influence the polarization (e.g., a degree of freedom) of light emitted by the QD-VCSEL. In a usage example, a QD-VCSEL with an FLC can include a bottom DBR and a middle DBR with the FLC layer on top of the middle layer. A top DBR can be included on top of the FLC layer. Other QD-VCSEL layouts, topologies, etc. are possible.

The electrical current can exit the bottom of the QD-VCSEL via one or more n-contacts. The n-contacts can include a single contact, a ring contact, a broken ring contact, etc. In the block diagram 300, the one or more n-contacts include n-contact 360 and n-contact 362. In a usage example, a p-contact ring and an n-contact ring can be concentric broken rings. By accessing a portion of the p-contact ring and the opposite (e.g., diagonally opposite) n-contact ring, a first polarization can be achieved. By accessing the previously unused portion of the p-contact and the previously unused portion of the n-contact, a second polarization can be achieved. In these cases, the electrical current flows from a first p-contact to a second n-contact (e.g., diagonal opposites), from a second p-contact to a first n-contact, and so on.

The QD-VCSEL emits light 380. The light from the QD-VCSEL can be emitted at an angle that can be substantially normal to a substrate, chip, PCB, interposer, etc. to which the QD-VCSEL can be coupled. When there is a purpose for the light emitted by the QD-VCSEL to be angled, then an optical device can be used. The purpose for angling the light can include enhancing optical coupling of the polarization-modulated beam (PMB). Embodiments include angling the DFMB that was emitted by the QD-VCSEL, wherein the angling is based on a micro-optical element (MOE). The MOE can include a micro lens, a diffractive optical element, a Fresnel lens, an asymmetric non-focusing optical device, and so on. The QD-VCSEL can comprise an inverted aperture QD-VCSEL. An inverted aperture QD-VCSEL can include a QD-VCSEL in which the aperture from which the light is emitted is fabricated using an inverted relief technique. The inverted aperture QD-VCSEL can also be created using an inverted p-n junction configuration. The inverted aperture QD-VCSEL can achieve improved mode control characteristics. The inverted aperture QD-VCSEL can be used to modulate a mode of the QD-VCSEL such as described above and can be used to encode optical data.

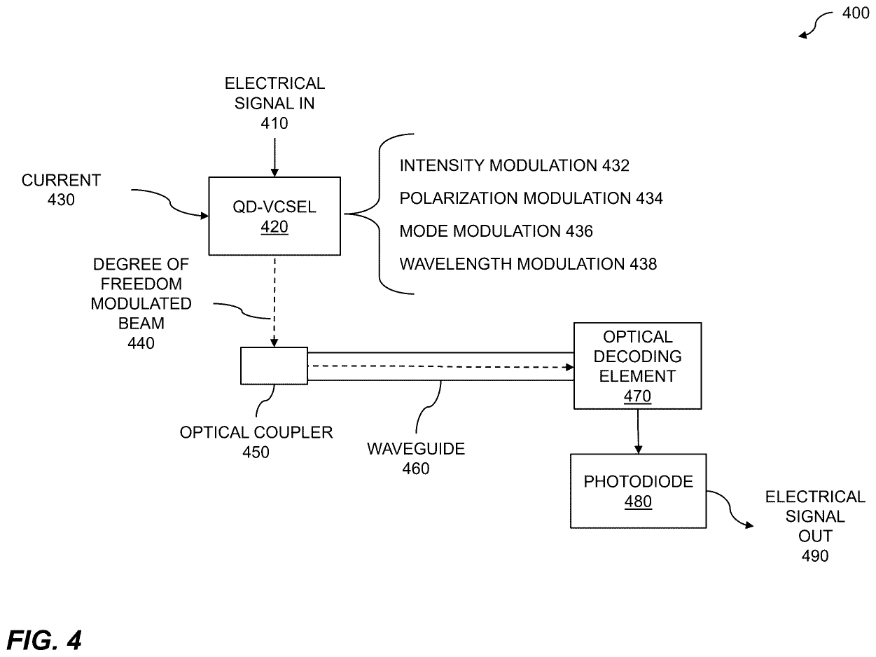

FIG. 4 is a block diagram of an optical link with QD-VCSEL modulation. An optical link with QD-VCSEL degree of freedom modulation enables transmitting data between a first circuit and a second circuit. One or more circuits and quantum dot vertical-cavity surface-emitting lasers (QD-VCSELs) are bonded to a front side of a directly modulated photonic wafer-scale interposer (PWSI). The PWSI also includes waveguides. A first circuit, which can be a first chiplet, sends electrical data. The electrical data is sent to a QD-VCSEL. The QD-VCSEL is modulated. The modulation causes the QD-VCSEL to emit a degree of freedom modulated beam (DFMB). The DFMB is based on the electrical data that was sent. The DFMB is coupled optically to a waveguide. The coupling optically can be accomplished using a grating coupler, a mirror, and so on. The waveguide is further coupled to an optical decoding element (ODE). The ODE decodes the DFMB into the electrical data. The electrical data that was decoded is delivered to a second circuit, which can be a second chiplet.

The block diagram 400 includes an electrical signal in 410. The electrical signal can represent data such as image data, video data, and audio data; artificial intelligence (AI) weights, biases, and data; natural language data; and so on. The electrical signal can represent parallel data such as a data set as bytes, words, double words, etc. The electrical data can represent serial data. The block diagram includes a quantum dot vertical-cavity surface-emitting laser (QD-VCSEL) 420. A QD-VCSEL can be a semiconductor laser fabricated on a chip. The QD-VCSEL can comprise a QD-VCSEL array. The QD-VCSEL array can include a plurality of QD-VCSELs. The fabrication can be based on gallium arsenide or another suitable material. In some embodiments, a substrate associated with each QD-VCSEL within the plurality of QD-VCSELs comprises gallium arsenide (GaAs). The QD-VCSEL can emit light in a direction perpendicular to the chip. The direction can be up (e.g., away from the chip) or down (e.g., into the chip). When light is emitted down, a window can be provided so that the light can escape through the back of the chip. To aid projection of the light, the substrate of the chip can be thinned. The light that is emitted can be coherent light that is in a wavelength range, such as 850 nm-950 nm. Other ranges are possible.

The block diagram 400 includes supplying current 430 to the QD-VCSEL. The current can comprise the basis for modulating a degree of freedom, such as phase, mode, or wavelength, of light emitted from the QD-VCSEL. In some embodiments, the degree of freedom comprises an intensity of the QD-VCSEL 432. The current can be altered to increase or decrease the intensity of the QD-VCSEL. In a usage example, as current is increased, the intensity of the QD-VCSEL increases. In other embodiments, the degree of freedom comprises a polarization of the QD-VCSEL 434. In other embodiments, the modulating is based on asymmetric current injection. The asymmetric current injection can affect the polarization of the light emitted by the QD-VCSEL. In a usage example, the light emitted by the QD-VCSEL can include an s-polarization, which includes polarization that is normal or perpendicular to a surface of incidence, or a p-polarization, which includes polarization that is parallel to a surface of incidence. In some embodiments, the degree of freedom comprises a mode of the QD-VCSEL 436. In some embodiments, the modulating comprises altering current to the QD-VCSEL. As described previously, a mode can include a transverse electromagnetic (TEM) mode. In a usage example, the TEM modes can include TEM₀₀, TEM₁₀, and TEM₀₁. The TEM₀₀ mode can include a fundamental mode, while the TEM₁₀ mode and the TEM₀₁ mode can include higher order modes. The altering current can change the transverse electromagnetic (TEM) mode of the QD-VCSEL. In other embodiments, the degree of freedom comprises a wavelength of the QD-VCSEL 438. In some embodiments, the modulating comprises injecting current into the QD-VCSEL. In further embodiments, the injecting includes altering a bias current to the QD-VCSEL. The altering the bias current can change current density within the active area of the QD-VCSEL. The altering current density can change a refractive index of the QD-VCSEL, and thereby change the resonance wavelength of the QD-VCSEL. The wavelength can be changed by QD-VCSEL chirp.

The block diagram 400 includes a degree of freedom modulated beam 440. Recall that data is sent from a first circuit to a QD-VCSEL. Embodiments include modulating a degree of freedom (DoF) of a light beam emitted by the QD-VCSEL, wherein the emitted light beam comprises a degree of freedom modulated beam (DFMB), wherein the DFMB is based on the electrical data that was sent. The DFMB can be directed through a QD-VCSEL window or aperture toward an optical coupler 450. The optical coupler can include a coupler on or within a circuit board, a wafer, an interposer, etc. The optical coupler can be based on a variety of optical elements, techniques, and so on. In some embodiments, the coupling optically is based on a grating coupler. The grating coupler can include a periodic grating that can transfer the DFMB with low loss into the waveguide. The coupling optically can be based on a mirror. In a usage example, the mirror can include a nano-imprint lithography mirror. The coupling optically can be based on a bent waveguide. The bent waveguide can include a containment region to minimize light loss. The coupling optically can be based on an off-axis diffractive lens. An off-axis diffractive lens can direct light at an angle with respect to the optical axis of the lens. Embodiments include angling the DFMB that was emitted by the QD-VCSEL, wherein the angling is based on a micro-optical element (MOE) (not shown). The angling the PMB can be used to complement an angle associated with the coupling the DFMB to the optical medium.

The block diagram includes a waveguide 460. The waveguide can comprise an optical medium that is capable of transferring the DFMB coupled to the waveguide by the optical coupler. Embodiments include coupling optically the DFMB to a waveguide within the plurality of waveguides, wherein the waveguide is further coupled to an optical decoding element. The waveguide can include a waveguide on or within a wafer, an interposer, and so on. In a usage example, the waveguide can be replaced by a fiber. The block diagram 400 includes an optical decoding element (ODE) 470 to which the waveguide is further coupled. The ODE can be based on a variety of optical elements, optical techniques, and so on. Embodiments include decoding, by the optical decoding element, the DFMB into the electrical data. The ODE can separate different degrees of freedom of light from the DFMB. The separated degrees of freedom of light (e.g., optical data) can be decoded into electrical data that was sent by the first circuit. The ODE can accomplish decoding the DFMB based on a variety of decoding techniques. In some embodiments, the optical decoding element comprises a grating coupler. The grating coupler can separate different degrees of freedom of light from each other. In a usage example, the separated degrees of freedom of light can be sent to optical receivers, where the optical receivers can convert the optical data to electrical data. In another usage example, the grating coupler can indicate when a first degree of freedom is active in the optical medium, which can comprise a logic “1.” The absence of the signal from the grating coupler can comprise a logic “0.” Clocking, such as clock and data recovery (CDR) circuits, can synchronize the WMB with the receiving and/or decoding circuits. In other embodiments, the optical decoding element comprises a polarization filter. The polarization filter can enable a first polarization of light to pass through the polarization filter while a second polarization of light is reflected by the polarization filter. In further embodiments, the optical decoding element comprises a polarization multiplexor (PMUX). The multiplexer can combine different polarizations when the DFMB is coupled optically to the waveguide, and the multiplexer can separate the different polarizations of the DFMB at the far end of the waveguide.

Some examples can include transforming each optical signal within at least two optical degree of freedom signals, by a unique photodiode, to an electrical signal. The transforming would then result in at least two electrical signals. The block diagram 400 includes a photodiode 480. More than one photodiode can be included, where each photodiode can transform or decode an optical signal into an electrical signal. In the block diagram 400, the ODE decodes the DFMB into the electrical data that was sent. The decoded DFMB is sent as an electrical signal out 490. Discussed previously, each optical signal within at least two optical degree of freedom signals is transformed by a unique photodiode to an electrical signal. The transforming results in at least two electrical signals. The at least two electrical signals can be assembled into a single electrical signal, where the single electrical signal comprises the electrical data that was sent. Embodiments include delivering the electrical data that was decoded to a second circuit within the plurality of circuits. The single electrical signal that includes the electrical data that was sent can be sent to a destination element such as a second circuit. The destination element can include a processor, an AI accelerator chiplet, a switching chiplet, etc. In some embodiments, the first circuit and the second circuit comprise a first chiplet and a second chiplet, respectively.

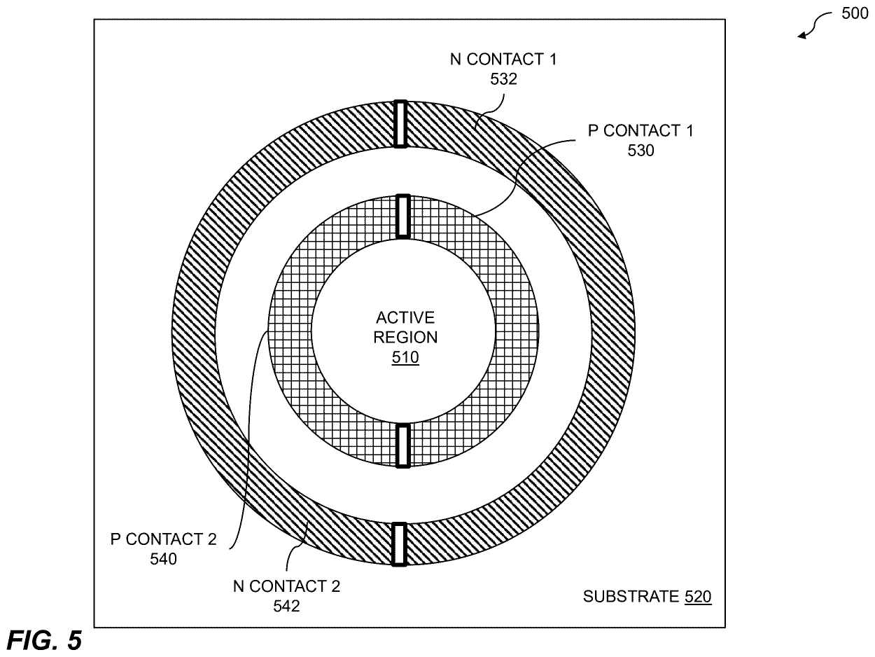

FIG. 5 is a diagram for asymmetric current injection for polarization modulation. The asymmetric current injection can be accomplished using contacts associated with a QD-VCSEL. Described previously, a degree of freedom of light emitted by a QD-VCSEL can comprise modulating a polarization of the QD-VCSEL. A first circuit sends electrical data. The electrical data is sent to a quantum dot vertical-cavity surface-emitting laser (QD-VCSEL). A polarization of the QD-VCSEL is modulated. The modulating can be based on asymmetric current injection. An injected asymmetrical current is a current that is unbalanced or unequal with respect to distribution and/or direction. The distribution and/or direction of the current can include a duration during which the current is positive, the current is negative, and so on. In a usage example, a current is asymmetrical about the x-axis, resulting in the asymmetrical current having a DC (e.g., nonzero) offset. The injection of the asymmetrical current can cause the QD-VCSEL to emit modulated light that includes a polarization. Thus, changing the injected asymmetrical current can change the polarization of the modulated, emitted light. The changing the injection of the asymmetrical current can be accomplished using contacts associated with the QD-VCSEL. The contacts can include n-contacts and p-contacts, where the n-contacts are based on an n-type diffusion or implantation, and the p-contacts are based on a p-type diffusion or implantation. The n-contacts and the p-contacts enable a directly modulated photonic wafer-scale interposer with optical links based on quantum dot VCSELs. The modulation causes the QD-VCSEL to emit a degree of freedom modulated beam (DFMB), where the DFMB comprises a polarization-modulated beam (PMB). The DFMB is based on the data that was sent by the first circuit. The DMFB is coupled optically to a waveguide. The coupling optically can be accomplished using a grating coupler, a mirror, and the like. The waveguide is further coupled to an optical decoding element (ODE). The ODE decodes the DMFB into the electrical data. The electrical data that was decoded is delivered to a second circuit. In some embodiments, the first circuit and the second circuit comprise a first chiplet and a second chiplet, respectively.

The FIG. 500 shows an active region 510 of the QD-VCSEL. Light to be emitted by the QD-VCSEL is generated within the active region. The active region can include one or more quantum dots. A top view of the QD-VCSEL shows a substrate 520. The substrate, which can be thinned, can comprise a variety of materials suitable to fabricating a QD-VCSEL such as a gallium arsenide (GaAs) substrate. In some embodiments, a substrate associated with each QD-VCSEL within the plurality of QD-VCSELs comprises gallium arsenide (GaAs). Other materials that can be used for the substrate can include aluminum-gallium-arsenide (AlGaAs), germanium (Ge), sapphire, and so on. The substrate can be thinned using a variety of fabrication techniques. The thinning the substrate can be accomplished by grinding, polishing, etching, and so on. The FIG. 500 shows p-contacts and n-contacts associated with a QD-VCSEL. The contacts can be configured based on various geometries such as rings, squares, and so on. The contacts can be based on a variety of contacts. In the figure, a p-contact comprises two segments, p-contact 1 530 and p-contact 2 540. The p-contact can include any number of segments. Also, in the figure, the n-contact comprises two segments, n-contact 1 532 and n-contact 2 542. While two segments are shown, the n-contact can also include any number of segments.

Modulating the polarization of the light emitted by the QD-VCSEL can be accomplished using asymmetric current injection into one or more p-contacts and one or more n-contacts. The asymmetric current can be injected using opposite pairs of p-contacts and n-contacts. In a usage example, a first pair of opposite contacts can include p-contact 1 and n-contact 2, and a second pair of opposite contacts can include p-contact 2 and n-contact 1.

Different polarization-modulated beams (PMBs) can be emitted by the QD-VCSEL depending on which p-contacts and which n-contacts are used for the current injection. Alternatively, current can be applied to the QD-VCSEL using all of the p-contacts and all of the n-contacts, a portion of the p-contacts and a portion of the n-contacts, adjacent p-contacts and n-contacts (such as p-contact 1 and n-contact 1), and so on.

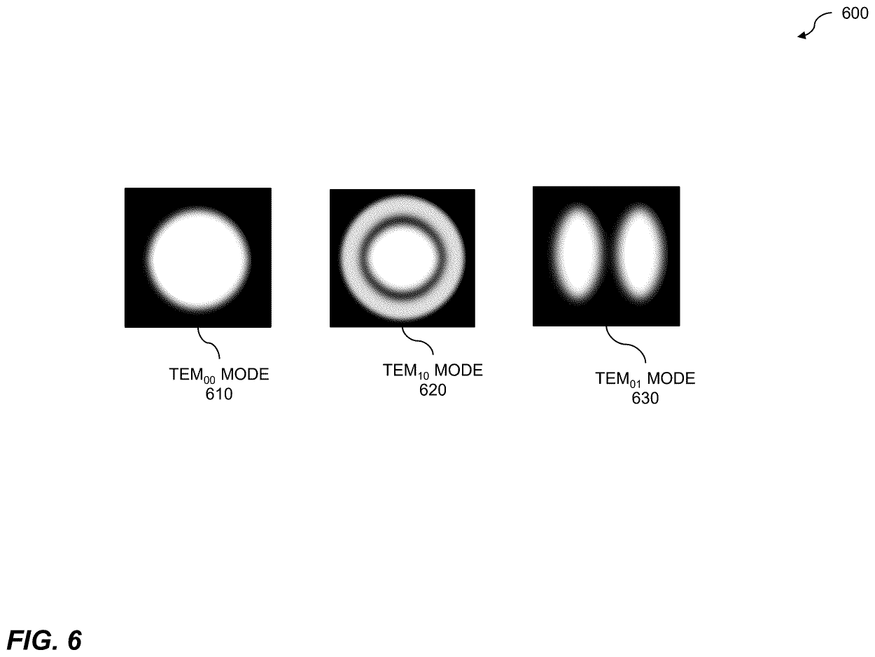

FIG. 6 is a diagram of transverse electromagnetic (TEM) modes. Described previously, the degree of freedom modulation of a QD-VCSEL can include a mode. The mode of a QD-VCSEL can be modulated by altering a current to the QD-VCSEL. The mode can include a transverse electromagnetic (TEM) mode, for which electric fields and magnetic fields are perpendicular to the direction of propagation of a wave, such as a light wave emitted by the QD-VCSEL. One or more TEM modes can be used to transmit data between electronic elements such as chips, chiplets, circuits, and so on, where the electronic elements can be co-located on a circuit board, wafer, interposer, and the like. The interposer can include a directly modulated photonic wafer-scale interposer (PWSI). The electronic elements can also be located on different boards, wafers, and interposers; located in different multiprocessors; located in different data racks or different datacenters; etc. The one or more transverse modes enable a directly modulated photonic wafer-scale interposer with optical links based on quantum dot VCSELs. An optical link that modulates QD-VCSEL modes enables transmitting data between a first circuit and a second circuit. In some embodiments, the first circuit and the second circuit comprise a first chiplet and a second chiplet, respectively. Circuits and QD-VCSELs are bonded to a front side of a PWSI. The PWSI includes waveguides. A first circuit sends electrical data. The electrical data is sent to a quantum dot vertical-cavity surface-emitting laser (QD-VCSEL). A degree of freedom that includes a mode of the QD-VCSEL is modulated. The modulating can be based on altering current to the QD-VCSEL. The modulation causes the QD-VCSEL to emit a mode-modulated beam (MMB). The MMB is based on the electrical data that was sent. The MMB is coupled optically to a waveguide. The coupling optically can be accomplished using a grating coupler, a mirror, etc. The waveguide is further coupled to a mode-dependent optical element (MDOE). The MDOE decodes the MMB into the electrical data. The electrical data that was decoded is delivered to a second circuit.

The FIG. 600 shows example transverse electromagnetic (TEM) waves. The TEM waves result from modulating a mode of a QD-VCSEL. The TEM modes, which can propagate via an optical medium such as a waveguide or an optical fiber, can transmit data between chips, chiplets, circuits, and so on. A variety of TEM modes can be modulated. In certain embodiments, the QD-VCSEL comprises a multimodal QD-VCSEL. The modulating modes of the QD-VCSEL can be accomplished by an electric current. In some embodiments, the modulating comprises altering current to the QD-VCSEL. The altering the current can include turning on a current and turning off a current, reversing a current, applying an asymmetric current, and so on. The multimodal QD-VCSEL can support one or more high order transverse modes. Thus, the modulating can be based on switching modes. The modulating can comprise switching between a lower order transverse mode and a high order transverse mode within the one or more high order transverse modes.

A variety of TEMs can be used for transmitting data. In a usage example, a lower order or fundamental mode can include TEM₀₀ 610. TEM₀₀ can comprise a Gaussian beam profile that includes a single peak in intensity at the center. One or more high order TEMs can be included in the variety of modulation modes. Two additional TEM modes can include TEM₁₀ 620 and TEM01 630. The subscripts associated with each TEM can denote an order of the mode in a horizontal direction and a vertical direction, respectively. The higher order modes can include a plurality of peak intensities and a plurality of nodes (e.g., an intensity substantially equal to zero). For TEM₁₀, there are two concentric intensity peaks. For TEM₀₁, there are two vertical, parallel intensity peaks. Other TEM modes can be used. The various TEM modes can be used to represent binary values. In a usage example, a first TEM mode can represent a binary one while a second TEM mode can represent a binary zero. In another usage example, the presence of a TEM mode can represent a binary one, while the absence of a TEM mode can indicate a binary zero. In a further usage example, two different TEM modes can represent a modulating of a data stream. For the latter usage example, the TEM mode can be captured and re-clocked in order to decode electrical data such as serial electrical data that was sent by the first circuit. The decoded data can be delivered to a second circuit.

The result of modulating the QD-VCSEL by altering current to the QD-VCSEL is a degree of freedom modulated beam (DFMB) that can comprise a mode-modulated beam (MMB), where the MMB is based on electrical data sent by a first circuit to the QD-VCSEL.

The MMB can be coupled to an optical medium such as a waveguide, a single mode fiber, and so on. The optical medium is coupled to a mode-dependent optical element (MDOE) which decodes the MMB into the electrical data that was sent. The electrical data that was decoded is delivered to a second circuit, thereby completing transmitting data from the first circuit to the second circuit.

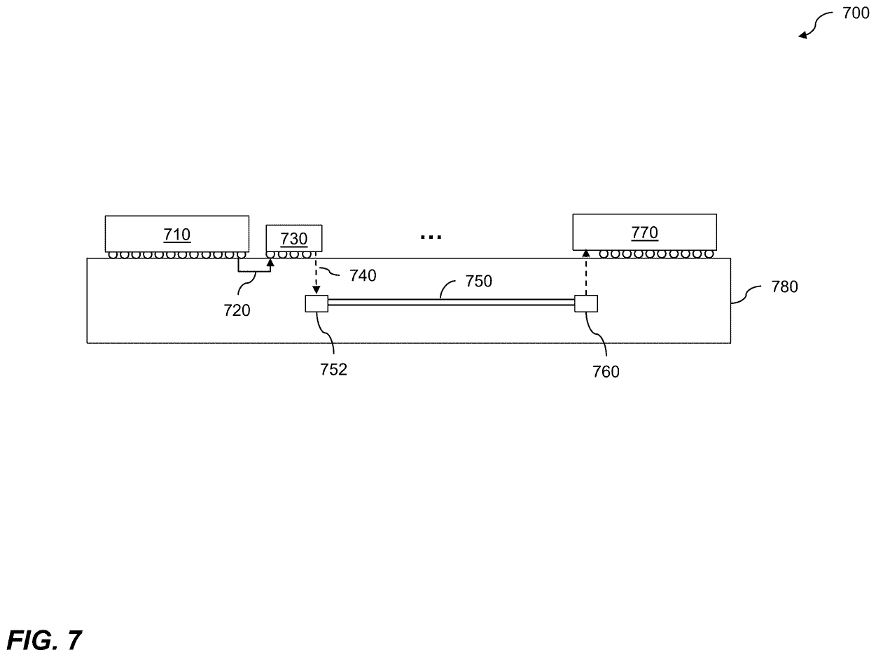

FIG. 7 is an apparatus for a directly modulated photonic wafer-scale interposer with optical links based on quantum dot VCSELS (QD-VCSELs). Optical links that enable transmitting data can be established. The optical links can be used to send data from a first circuit to a second circuit. In certain embodiments, the first circuit and the second circuit comprise a first chiplet and a second chiplet, respectively. The first circuit and the second circuit can be co-located on a circuit board, wafer, or interposer; located in different multiprocessors; located in different datacenters; and so on. The interposer can include a photonic wafer-scale interposer. A first circuit sends electrical data to a quantum dot vertical-cavity surface-emitting laser (QD-VCSEL). The QD-VCSEL converts electrical data into optical data (e.g., light data) by modulating a light beam. The QD-VCSEL modulation includes modulating a degree of freedom (DoF) of a light beam emitted by the QD-VCSEL, wherein the emitted light beam comprises a degree of freedom modulated beam (DFMB). The degree of freedom modulation can include one or more of intensity modulation, polarization modulation, mode modulation, wavelength modulation, and so on. The DFMB is based on the electrical data that was sent. By coupling the modulated beam to an optical medium such as a waveguide, a fiber, and so on, the DFMB is sent via the optical medium to an optical decoding element (ODE). The ODE decodes the DFMB to electrical data. The electrical data is delivered to the second circuit. The apparatus enables transmitting data using a directly modulated photonic wafer-scale interposer with optical links based on quantum dot VCSELs.

An apparatus is disclosed for transmitting data comprising: a directly modulated photonic wafer-scale interposer (PWSI), wherein the PWSI includes a plurality of waveguides, and wherein a plurality of circuits and a plurality of quantum dot vertical-cavity surface-emitting laser (QD-VCSELs) are bonded to a front side of the PWSI; a first circuit within the plurality of circuits, wherein the first circuit is coupled to a QD-VCSEL within the plurality of QD-VCSELs, wherein the first circuit sends electrical data to the QD-VCSEL, and wherein the QD-VCSEL, when modulated, emits a degree of freedom modulated beam (DFMB); an optical coupler, wherein the optical coupler couples optically the DFMB to a waveguide within the plurality of waveguides; an optical decoding element, wherein the optical decoding element is further coupled to the waveguide, and wherein the optical decoding element decodes the DFMB into the electrical data that was sent; and a second circuit within the plurality of circuits, wherein the second circuit receives the electrical data that was decoded.

The apparatus 700 includes a first circuit 710 within a plurality of circuits, wherein the first circuit is coupled to a QD-VCSEL within a plurality of QD-VCSELs, wherein the first circuit sends electrical data to the QD-VCSEL, and wherein the QD-VCSEL, when modulated, emits a degree of freedom modulated beam (DFMB). The modulating can be based on current. The current can be injected, altered, and so on. In some embodiments, the modulating is based on asymmetric current injection. The asymmetry of the current can be relative to an x-axis (e.g., can include a DC offset), can be based on a forward current and a reverse current, can be related to a pulse train, etc. In a usage example, the asymmetric current injection can be used to control a polarization of the light emitted by the QD-VCSEL. In other embodiments, the modulating comprises altering current to the QD-VCSEL. The altering the current can include increasing and decreasing the current, reversing the current, applying and removing the current, etc. In a usage example, the altering the current can control a mode such as a TEM mode of light emitted by the QD-VCSEL. In further embodiments, the modulating comprises injecting current into the QD-VCSEL. The injecting the current can change carrier density with an active region of the QD-VCSEL. In a usage example, the injecting current can control a wavelength of light emitted by the QD-VCSEL.

Noted above, the first circuit sends data 720 to a second circuit 770 using the QD-VCSEL and/or additional optical elements. The circuits can be connected, attached, bonded, or otherwise coupled to a circuit board, a wafer, an interposer, and so on. In embodiments, the interposer comprises a directly modulated photonic wafer-scale interposer (PWSI), wherein the PWSI includes a plurality of waveguides, and wherein a plurality of circuits and a plurality of quantum dot vertical-cavity surface-emitting laser (QD-VCSELs) are bonded to a front side of the PWSI. While two circuits and one QD-VCSEL are shown, the apparatus can include any number of circuits and any number of QD-VCSELs. The circuits can include AI accelerators, switching circuits, ASICs, I/O circuits, and so on. In embodiments, the plurality of circuits includes a plurality of chiplets, and wherein the first circuit and the second circuit comprise a first chiplet within the plurality of chiplets and a second chiplet within the plurality of chiplets, respectively. In some embodiments, the PWSI comprises an optical wafer-scale AI accelerator, wherein one or more chiplets within the plurality of chiplets comprise one or more artificial intelligence (AI) accelerators. The AI accelerator can be used for machine learning (ML), natural language processing (NLP), and the like. In other embodiments, the PWSI comprises an optical wafer-scale network switch, wherein one or more chiplets within the plurality of chiplets comprise one or more switching chiplets. The network switch can be used to provide data to compute-intensive applications such as AI, ML, image processing, etc.

The first circuit 710 sends electrical data 720 to the QD-VCSEL 730. The QD-VCSEL can include a single QD-VCSEL, a plurality of QD-VCSELs, a QD-VCSEL array, and so on. In embodiments, the QD-VCSEL, when modulated, emits a degree of freedom modulated beam (DFMB) 740. The DFMB can include a modulated light polarization, a modulated light mode, a modulated light wavelength, a modulated intensity, etc. In a usage example, the DFMB can include two wavelengths, where one wavelength represents a logic one and the second wavelength represents a logic zero. The first circuit can send data to other surface-emitting light sources that can be modulated, such as light emitting diodes (LEDs), laser diodes (LDs), and the like.

The DFMB 740 emitted by the QD-VCSEL is conveyed to an optical coupler 752. The apparatus 700 includes an optical coupler, wherein the optical coupler couples optically the DFMB to a waveguide within the plurality of waveguides. The waveguide 750 can comprise an optical medium which can be a low loss optical medium appropriate for sending the DFMB. The optical medium can include an optical fiber. In a usage example, the optical medium can include a degree of freedom maintaining fiber. In some embodiments, the coupling optically is based on a grating coupler. The grating coupler can include a periodic grating that can transfer the DFMB with low loss into the optical medium. The coupling optically can be based on a bent waveguide. The bent waveguide can include a high containment region, where the high containment region minimizes loss from the DFMB. The coupling optically can be based on an off-axis diffractive lens. The off-axis diffractive lens can be based on surfaces comprising different thicknesses or heights that diffract light, thereby bending and focusing the light onto an input aperture of a waveguide. The coupling optically can be based on a mirror. In a usage example, the mirror can include a nano-imprint lithography mirror. Embodiments include angling the DFMB that was emitted by the QD-VCSEL, wherein the angling is based on a micro-optical element (MOE). The angling the DFMB can be used to complement an angle associated with the coupling the DFMB to the optical medium. The angling can also compensate for variations in a wafer or interposer across the surface of the wafer or interposer. In a usage example, the DFMB emitted by the QD-VCSEL can be pre-angled to an angle such as 9.74 degrees, substantially 9.74 degrees, or another angle, and a mirror such as a crystallographic etched mirror can include an angle such as 54.74 degrees, substantially 54.74 degrees, or another angle. The combination of pre-angling and angling can enable coupling the WMB to a waveguide at an angle substantially normal to an entrance aperture of the waveguide.

The micro-optical element (MOE) can be based on one or more optical techniques. The MOE can comprise a micro lens. The micro lens can be coupled to a first surface-emitting light source such as the QD-VCSEL, a laser diode (LD), etc. The micro lens can pre-angle the emitted light. The MOE can comprise a diffractive optical element. The diffractive optical element can create a light phase profile that can focus, shape, or split the emitted light. The MOE can comprise a Fresnel lens. The Fresnel lens can use concentric grooves or rings to focus the emitted light. The MOE can comprise an asymmetric non-focusing optical device. The asymmetric non-focusing optical device can enable light to transmit through the device preferentially, where the light can pass through more easily in one direction than another direction. The asymmetric non-focusing optical device can couple light to an optical medium such as a waveguide and can suppress a portion of reflected light back to the surface-emitting light source.

The apparatus 700 includes an optical decoding element (ODE) 760, wherein the optical decoding element is further coupled to the waveguide, and wherein the optical decoding element decodes the DFMB into the electrical data that was sent. The ODE can separate different degrees of freedom of light from the DFMB. The separated degrees of freedom can be based on light intensities, light polarizations, light modes such as TEM modes, light wavelengths, etc. The separated degrees of freedom of light (e.g., optical data) can be decoded into electrical data that was sent by the first circuit. As described above and throughout, the ODE can accomplish decoding based on a plurality of decoding techniques. In some embodiments, the optical decoding element comprises a grating coupler. The grating coupler can separate different polarizations of light. In other embodiments, the optical decoding element comprises a polarization filter. The polarization filter can enable a first light polarization to pass through the filter while reflecting a second light polarization. In further embodiments, the optical decoding element comprises a polarization multiplexor (PMUX). The PMUX can multiplex two or more light polarizations.

The apparatus 700 includes a second circuit 770 within the plurality of circuits, wherein the second circuit receives the electrical data that was decoded. The second circuit can receive the transmitted data that was sent by the first circuit. The first circuit and the second circuit can be located on a different or a common circuit board, a different or a common wafer, a different or a common interposer, a different or a common rack, and so on. The first circuit and the second circuit can be remotely located with respect to each other. “Remotely located” can include locating the first circuit and the second circuit in separate circuit boards or wafers, separate multiprocessors, separate data racks, separate data centers, and so on. As shown in the figure, the apparatus 700 includes a directly modulated photonic wafer-scale interposer (PWSI) 780, wherein the PWSI includes a plurality of waveguides, and wherein a plurality of circuits and a plurality of vertical-cavity surface-emitting lasers (QD-VCSELs) are bonded to a front side of the PWSI. The first circuit, the second circuit, and the QD-VCSEL can be coupled to a circuit board, included within a chip, etc. Recall that the first circuit and the second circuit comprise a first chiplet and a second chiplet, respectively. In a usage example, the first chiplet, the second chiplet, and the QD-VCSEL are within a plurality of chiplets bonded to a front side of a directly modulated photonic wafer-scale interposer (PWSI). The PWSI further comprises a plurality of waveguides and a plurality of through-silicon vias (TSVs). The optical medium comprises a waveguide within the plurality of waveguides.

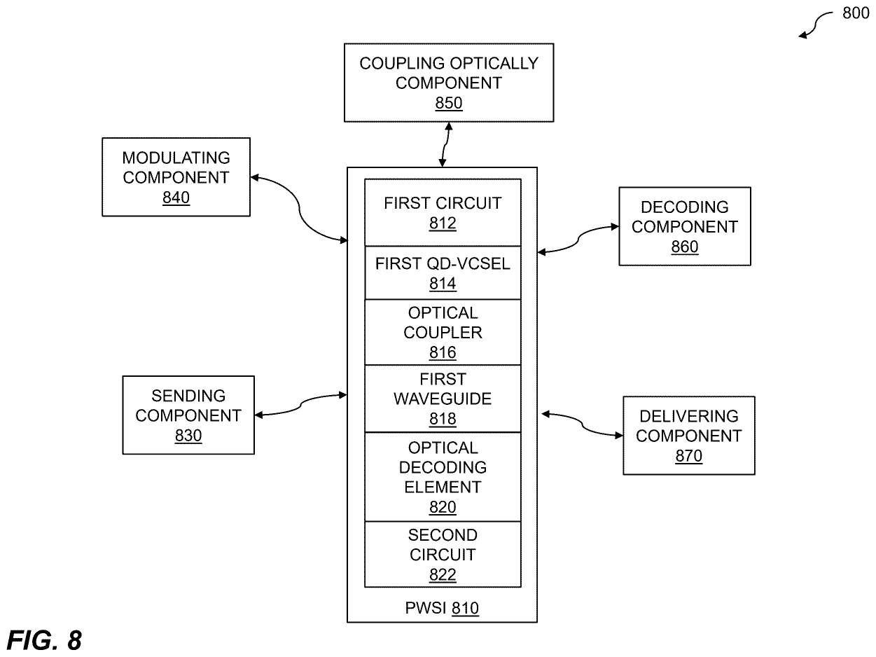

FIG. 8 is a system diagram for a directly modulated photonic wafer-scale interposer with optical links based on quantum dot VCSELS (QD-VCSELs). Optical links based on waveguides, optical fibers, etc. enable transmitting of data between circuits bonded to a directly modulated photonic wafer-scale interposer (PWSI). The transmitting of data is accomplished using quantum dot vertical-cavity surface-emitting lasers (QD-VCSELs) to convert electrical data into optical data. The first circuit and the second circuit can be co-located on a circuit board, wafer, or interposer; located in different multiprocessors, boards, wafers, or interposers; located in different datacenters; and so on. The interposer can include a photonic wafer-scale interposer. A first circuit sends electrical data to a quantum dot vertical-cavity surface-emitting laser (QD-VCSEL). The QD-VCSEL converts electrical data into optical data (e.g., light data) by modulating a light beam. The QD-VCSEL modulation includes modulating a degree of freedom (DoF) of a light beam emitted by the QD-VCSEL, wherein the emitted light beam comprises a degree of freedom modulated beam (DFMB). Noted throughout, the degree of freedom modulation can include polarization modulation, mode modulation, wavelength modulation, and so on. The DFMB is based on the electrical data that was sent. By coupling the modulated beam to an optical medium such as a waveguide, a fiber, and so on, the DFMB is sent via the optical medium to an optical decoding element (ODE). The ODE decodes the DFMB to electrical data. The electrical data that was decoded is delivered to the second circuit. The system enables transmitting data using a directly modulated photonic wafer-scale interposer with optical links based on quantum dot VCSELs.

Disclosed is a system for transmitting data comprising: a directly modulated photonic wafer-scale interposer (PWSI), wherein the PWSI includes a plurality of waveguides, and wherein a plurality of circuits and a plurality of quantum dot vertical-cavity surface-emitting laser (QD-VCSELs) are bonded to a front side of the PWSI; a first circuit within the plurality of circuits, wherein the first circuit is coupled to a QD-VCSEL within the plurality of QD-VCSELs; an optical coupler, wherein the optical coupler couples optically a light beam emitted from the QD-VCSEL to a waveguide with the plurality of waveguides; an optical decoding element, wherein the optical decoding element is further coupled to the waveguide; and a second circuit within the plurality of circuits; wherein the system is configured to: send electrical data, by the first circuit to the QD-VCSEL; modulate a property of the QD-VCSEL, wherein modulating includes emitting, by the QD-VCSEL, a degree of freedom modulated beam (DFMB), wherein the DFMB is based on the electrical data that was sent; couple optically, by the optical coupler, the DFMB to the waveguide; decode, by the optical decoding element, the DFMB into the electrical data; and deliver the electrical data that was decoded to the second circuit.

The system 800 includes a directly modulated photonic wafer-scale interposer (PWSI) 810, wherein the PWSI includes a plurality of waveguides, and wherein a plurality of circuits and a plurality of quantum dot vertical-cavity surface-emitting lasers (QD-VCSELs) are bonded to a front side of the PWSI. The PWSI can comprise a silicon wafer, a glass wafer, and so on. The bonding the circuits to the PWSI can include coupling the chiplets to metal layers, interconnect, wires, etc. on and within the PWSI. The bonding the QD-VCSELs to the PWSI can comprise coupling the QD-VCSELs to wires, interconnects, and so on, on or within the PWSI. The system 800 includes a first circuit within the plurality of circuits, wherein the first circuit is coupled to a QD-VCSEL within the plurality of QD-VCSELs 814. The first circuit 812 can include a chiplet within a plurality of chiplets. The chiplets can include processor chiplets, memory chiplets, AI accelerator chiplets, switching chiplets, I/O chiplets, and the like. Other surface-emitting light sources can also be used, such as a laser diode.

The system includes a QD-VCSEL. A QD-VCSEL can be a semiconductor laser which can be fabricated on a chip. The QD-VCSEL can comprise a QD-VCSEL array. The QD-VCSEL array can include a plurality of QD-VCSELs. The QD-VCSEL can emit light in a direction perpendicular to the chip. The direction can be up (e.g., away from the chip) or down (e.g., into the chip). When light is emitted down, a window can be provided so that the light can escape through the back of the chip. The light that is emitted can be coherent light that is in a wavelength range, such as 850 nm-950 nm. Other ranges are possible. QD-VCSELs can include quantum dots. In embodiments, each QD-VCSEL within the plurality of QD-VCSELs includes one or more quantum dots within an active region, wherein the one or more quantum dots confine a plurality of carriers in three dimensions. A quantum dot can comprise a semiconductor particle that can exhibit behavior similar to that of an individual atom (e.g., discrete atomic energy levels). Since the confinement can be different from a quantum well VCSEL, a QD-VCSEL can exhibit better electrical characteristics such as lower threshold current, sharper gain spectrum, better temperature sensitivity, and so on. Quantum dots can be manufactured to emit specific wavelengths of light by modifying various properties of the quantum dots including shape, size, and transparency.

The system 800 includes an optical coupler 816, wherein the optical coupler couples optically a light beam emitted from the QD-VCSEL to a waveguide 818 within the plurality of waveguides. The light beam emitted by the QD-VCSEL includes a degree of freedom modulated beam (DFMB). The optical coupler can couple optically the emitted light beam to other optical media. The other optical media can include an optical fiber. In a usage example, the optical medium can comprise a degree of freedom maintaining fiber. Various optical elements can be used as an optical coupler to optically couple a degree of freedom modulated beam (DFMB) to the optical element. The coupling optically can be accomplished using the optical coupler. The optical coupler can comprise a grating coupler. The grating coupler can include a periodic grating that can transfer the DFMB with low loss into the optical medium. The optical coupler can comprise a mirror. In a usage example, the mirror can include a nano-imprint lithography mirror. Embodiments include angling the DFMB that was emitted by the QD-VCSEL, wherein the angling is based on a micro-optical element (MOE). The angling the polarization-modulated beam (PMB) can be used to complement an angle associated with the coupling the PMB to the optical medium.

The system 800 includes an optical decoding element (ODE) 820, wherein the optical decoding element is further coupled to a waveguide. The ODE can distinguish among different degrees of freedom of light within the DFMB emitted by the QD-VCSEL. The ODE can separate different degrees of freedom including polarizations of light, modes of light, wavelengths of light, etc. The separated degrees of freedom of light can be decoded into electrical data that was sent by the first circuit. The ODE can accomplish decoding based on a plurality of decoding techniques. In some embodiments, the optical decoding element comprises a grating coupler. The grating coupler can separate different polarizations, modes, and wavelengths in the DFMB from each other. The separated degrees of freedom of light can be sent to optical receivers that convert the optical data to electrical data. In a usage example, an optical receiver can comprise a photodiode. In a usage example, light emitted from the QD-VCSEL is modulated based on polarization. In other embodiments, the optical decoding element comprises a polarization filter. A polarization filter can enable passage of light with a polarization that is compatible with the polarization filter, while substantially filtering out light with polarizations that are incompatible with the polarization filter. In further embodiments, the optical decoding element comprises a polarization multiplexor (PMUX). The PMUX separates light that includes two or more polarizations. In a usage example, the received light is separated into two or more beams, where each beam is based on a single polarization. In a usage example, a beam splitter can reflect light associated with a first polarization and transmit light associated with a second polarization.

The system 800 includes a second circuit 822 within the plurality of circuits. The second circuit can be a circuit substantially similar to or different than the first circuit. The first circuit and the second circuit can comprise separate cores, cores on a wafer, chiplets, SoCs, ASICs, or any of the above on different wafers, interposers, and so on. The first circuit and the second circuit can comprise circuits within same or different chips, chiplets, SoCs, wafers, interposers, etc. The first circuit and the second circuit can comprise processors, multi-core processors, memory controllers, memory chips such as DDR or HBM chips, I/O chips, AI accelerators, switching chips, and so on. In some embodiments, the first circuit and the second circuit comprise a first chiplet and a second chiplet, respectively. In a usage example, the first chiplet and the second chiplet comprise artificial intelligence (AI) accelerators. In a second usage example, the first chiplet and the second chiplet comprise switching chiplets. The second chiplet can be substantially different in function, type of chip, pin layout, etc. than the first chiplet. The second chiplet can be co-located within a plurality of chiplets that also includes the first chiplet. The second chiplet can be located remotely from the first chiplet.

The system 800 includes a sending component 830. The sending component is configured to send electrical data, by the first circuit to the QD-VCSEL. The data can be sent by the first circuit to the QD-VCSEL using one or more of wires, interconnect, metal layers, etc. The metal layers can include metal layers within a circuit board, a wafer, an interposer, and so on. The metal layers, which enable interconnection between and among circuits, chiplets, and other elements, can be fabricated on or within a circuit board, wafer, or interposer such as the directly modulated PWSI, etc. Using the metal layers can offer significant communication speed due to short wire lengths, and reduced “parasitics” such as resistance, capacitance, and inductance. The QD-VCSEL can emit light based on the sent data. The emitted light represents the data as optical data. The emitted light can be modulated.

The system 800 includes a modulating component 840. The modulating component is configured to modulate a property of the QD-VCSEL, wherein modulating includes emitting, by the QD-VCSEL, a degree of freedom modulated beam (DFMB), wherein the DFMB is based on the electrical data that was sent. As described above and throughout, the DFMB can include a beam with a plurality of degrees of freedom such as intensities, polarizations, modes, wavelengths, etc. In a usage example, the DFMB can include two degrees of freedom, where one degree of freedom represents a logic one and the second degree of freedom represents a logic zero. In another usage example, two degrees of freedom can represent two different serial data streams. The first circuit can send data to other surface-emitting light sources that can be modulated, such as laser diodes (LDs).

The system 800 includes a coupling optically component 850. The coupling optically component is configured to couple optically, by the optical coupler, the DFMB to the waveguide. The coupling optically can be used to couple the DFMB to other optical media such as an optic fiber. An optical medium can include a low loss optical medium appropriate for sending the DFMB. The optical medium can comprise a degree of freedom maintaining fiber. The coupling optically is accomplished using an optical coupler. A variety of optical couplers can be used, as described above. The optical coupler can include a grating coupler, a mirror, and so on.

The system 800 includes a decoding component 860. The decoding component is configured to decode, by the optical decoding element, the DFMB into the electrical data. The optical decoding element (ODE) can separate distinct degrees of freedom of light from the DFMB. The decoded electrical data is the data that was sent by the first circuit. As described above and throughout, the ODE can accomplish decoding based on a plurality of decoding techniques, such as a grating coupler, a polarization filter, a polarization mux, and so on. The system 800 includes a delivering component 870. The delivering component is configured to deliver the electrical data that was decoded to the second circuit. The electrical data can be delivered by the delivering component to the second circuit using wire, interconnect, metal layers, fiberoptic cable, and so on. The metal layers can include metal layers within a circuit board, a wafer, an interposer, a PWSI, and so on. The metal layers, which enable interconnection between and among circuits, chiplets and other elements, can be fabricated on or within a board, wafer, interposer, etc. As was the case for sending the data from the first circuit to the QD-VCSEL, using the metal layers can offer significant communication speed due to short wire lengths, and reduced “parasitics” such as resistance, capacitance, and inductance. The second circuit can process the delivered data, forward the delivered data, etc.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A method for transmitting data comprising:
bonding, to a front side of a directly modulated photonic wafer-scale interposer (PWSI), a plurality of circuits and a plurality of quantum dot vertical-cavity surface-emitting lasers (QD-VCSELs), wherein the PWSI includes a plurality of waveguides;
sending electrical data, by a first circuit within the plurality of circuits, to a QD-VCSEL within the plurality of QD-VCSELs;
modulating a degree of freedom (DoF) of a light beam emitted by the QD-VCSEL, wherein the emitted light beam comprises a degree of freedom modulated beam (DFMB), wherein the DFMB is based on the electrical data that was sent;
coupling optically the DFMB to a waveguide within the plurality of waveguides, wherein the waveguide is further coupled to an optical decoding element;
decoding, by the optical decoding element, the DFMB into the electrical data; and
delivering the electrical data that was decoded to a second circuit within the plurality of circuits.

2. The method of claim 1 wherein each QD-VCSEL within the plurality of QD-VCSELs includes one or more quantum dots within an active region, wherein the one or more quantum dots confine a plurality of carriers in three dimensions.

3. The method of claim 2 wherein a substrate associated with each QD-VCSEL within the plurality of QD-VCSELs comprises gallium arsenide (GaAs).

4. The method of claim 1 wherein the optical decoding element comprises a grating coupler.

5. The method of claim 1 wherein the degree of freedom comprises an intensity of the QD-VCSEL.

6. The method of claim 1 wherein the degree of freedom comprises a polarization of the QD-VCSEL.

7. The method of claim 6 wherein the modulating is based on asymmetric current injection.

8. The method of claim 6 wherein the optical decoding element comprises a polarization filter.

9. The method of claim 6 wherein the optical decoding element comprises a polarization multiplexor (PMUX).

10. The method of claim 6 wherein the QD-VCSEL includes a ferroelectric liquid crystal layer (FLC).

11. The method of claim 1 wherein the degree of freedom comprises a mode of the QD-VCSEL.

12. The method of claim 11 wherein the modulating comprises altering current to the QD-VCSEL.

13. The method of claim 12 wherein the QD-VCSEL comprises a multimodal QD-VCSEL.

14. The method of claim 11 wherein a fundamental mode of the QD-VCSEL comprises a higher order mode than a non-fundamental mode.

15. The method of claim 1 wherein the degree of freedom comprises a wavelength of the QD-VCSEL.

16. The method of claim 15 wherein the modulating comprises injecting current into the QD-VCSEL.

17. The method of claim 16 wherein the modulating is based on QD-VCSEL chirp.

18. The method of claim 16 wherein the injecting includes altering a bias current to the QD-VCSEL.

19. The method of claim 1 wherein the coupling optically is based on a grating coupler.

20. The method of claim 19 further comprising angling the DFMB that was emitted by the QD-VCSEL, wherein the angling is based on a micro-optical element (MOE).

21. The method of claim 1 wherein the first circuit and the second circuit comprise a first chiplet and a second chiplet, respectively.

22. The method of claim 1 wherein at least one waveguide in the plurality of waveguides comprises a first distance, wherein the first distance is greater than an exposure, on the PWSI, of a single photomask reticle.

23. The method of claim 22 wherein the at least one waveguide is fabricated using a nanoimprint lithography (NIL) process.

24. An apparatus for transmitting data comprising:
a directly modulated photonic wafer-scale interposer (PWSI), wherein the PWSI includes a plurality of waveguides, and wherein a plurality of circuits and a plurality of quantum dot vertical-cavity surface-emitting lasers (QD-VCSELs) are bonded to a front side of the PWSI;
a first circuit within the plurality of circuits, wherein the first circuit is coupled to a QD-VCSEL within the plurality of QD-VCSELs, wherein the first circuit sends electrical data to the QD-VCSEL, and wherein the QD-VCSEL, when modulated, emits a degree of freedom modulated beam (DFMB);
an optical coupler, wherein the optical coupler couples optically the DFMB to a waveguide within the plurality of waveguides;
an optical decoding element, wherein the optical decoding element is further coupled to the waveguide, and wherein the optical decoding element decodes the DFMB into the electrical data that was sent; and
a second circuit within the plurality of circuits, wherein the second circuit receives the electrical data that was decoded.

25. The apparatus of claim 24 wherein the plurality of circuits includes a plurality of chiplets, and wherein the first circuit and the second circuit comprise a first chiplet within the plurality of chiplets and a second chiplet within the plurality of chiplets, respectively.

26. The apparatus of claim 25 wherein the PWSI comprises an optical wafer-scale AI accelerator, wherein one or more chiplets within the plurality of chiplets comprise one or more artificial intelligence (AI) accelerators.

27. The apparatus of claim 25 wherein the PWSI comprises an optical wafer-scale network switch, wherein one or more chiplets within the plurality of chiplets comprise one or more switching chiplets.

28. A system for transmitting data comprising:
a directly modulated photonic wafer-scale interposer (PWSI), wherein the PWSI includes a plurality of waveguides, and wherein a plurality of circuits and a plurality of quantum dot vertical-cavity surface-emitting lasers (QD-VCSELs) are bonded to a front side of the PWSI;
a first circuit within the plurality of circuits, wherein the first circuit is coupled to a QD-VCSEL within the plurality of QD-VCSELs;
an optical coupler, wherein the optical coupler couples optically a light beam emitted from the QD-VCSEL to a waveguide with the plurality of waveguides;
an optical decoding element, wherein the optical decoding element is further coupled to the waveguide; and
a second circuit within the plurality of circuits;
wherein the system is configured to:
send electrical data, by the first circuit to the QD-VCSEL;
modulate a property of the QD-VCSEL, wherein modulating includes emitting, by the QD-VCSEL, a degree of freedom modulated beam (DFMB), wherein the DFMB is based on the electrical data that was sent;
couple optically, by the optical coupler, the DFMB to the waveguide;
decode, by the optical decoding element, the DFMB into the electrical data; and
deliver the electrical data that was decoded to the second circuit.
